(19) United States
(12) Patent Application Publication
(10) Pub. No.: US 2025/0158125 A1
(43) Pub. Date: May 15, 2025

(54) ELECTROLYTE ADDITIVE COMPOUNDS FOR HIGH VOLTAGE ENERGY STORAGE DEVICE, AND ASSOCIATED PROCESSES

(71) Applicant: Tesla, Inc., Austin, TX (US)

(72) Inventors: Sunhyung Jurng, South San Francisco, CA (US); Sanketh Gowda, Fremont, CA (US); Vineet Haresh Mehta, Mountain View, CA (US); Saad Mohammad Azam, Halifax (CA); Wentao Song, Halifax (CA); Connor P. Aiken, Bedford (CA); Jeffery R. Dahn, Halifax (CA); Zhengcheng Zhang, Naperville, IL (US); Quinton Meisner, Westmont, IL (US); Qian Liu, Darien, IL (US)

(73) Assignee: UChicago Argonne, LLC, Chicago, IL (US)

(21) Appl. No.: 18/838,996

(22) PCT Filed: Feb. 22, 2023
(86) PCT No.: PCT/US2023/013633

§ 371 Date: Aug. 15, 2024

Related U.S. Application Data
(60) Provisional application No. 63/313,109, filed on Feb. 23, 2022.

(51) Int. Cl. H01M 10/0567; H01M 10/0525

(52) U.S. Cl. CPC H01M 10/0567; H01M 10/0525; H01M 2300/0025

(57) ABSTRACT

Provided herein are electrolyte additives and formulations for energy storage devices having improved performance. The improved performance may be realized as improved cycling stability at abusive testing conditions.

### INCORPORATION BY REFERENCE TO ANY PRIORITY APPLICATIONS

This application claims the benefit of U.S. Provisional Patent Application No. 63/313,109, titled “ADDITIVE COMPOUNDS FOR HIGH VOLTAGE ENERGY STORAGE DEVICE ELECTROLYTES, AND PROCESSES THEREOF,” filed Feb. 23, 2022, the disclosure of which is incorporated herein by reference in its entirety and for all purposes.

### BACKGROUND

### Field

The present disclosure relates generally to energy storage devices, and specifically to improved electrolyte formulations for use in energy storage devices.

### Description of the Related Art

Energy storage devices are widely used to provide power to electronic, electromechanical, electrochemical, and other useful devices. Such cells include primary chemical cells, secondary (rechargeable) cells, fuel cells, and various species of capacitors, including ultracapacitors. Increasing the operating voltage and temperature of energy storage devices, including batteries and capacitors, would be desirable for enhancing energy storage, increasing power capability, and broadening real-world use cases.

Lithium ion batteries have been relied on as a power source in numerous commercial and industrial uses, for example, in consumer devices, productivity devices, and in battery powered vehicles. However, demands placed on energy storage devices are continuously—and rapidly—growing. For example, the automotive industry is developing vehicles that rely on compact and efficient energy storage, such as plug-in hybrid vehicles and pure electric vehicles. Lithium ion batteries are well suited to meet future demands however improvements in energy density are needed to provide longer life batteries that can travel further on a single charge. The electrolyte is one component in conventional lithium ion batteries that determines electrochemical performance as well as safety of those batteries, where the compatibility between electrode and electrolyte in part governs battery cell performance.

In conventional lithium ion batteries, discharge rates less than about C/5 are typically manageable by higher energy electrode designs, where C/5 is a discharge current relative to cell capacity such that the cell is drained in 5 hours. However, as the electrodes become thicker (as correlated with higher cell energy), the electrolyte formulation becomes increasingly important to address discharge performance at higher C-rates (1C and above), in addition to improving cell lifetime under high voltage and high temperature conditions.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Some embodiments of the present disclosure relate to an electrolyte comprising at least one of Formula (A), Formula (B), Formula (C), Formula (D), or a polymeric component that comprises a unit of Formula (E), or a salt thereof:

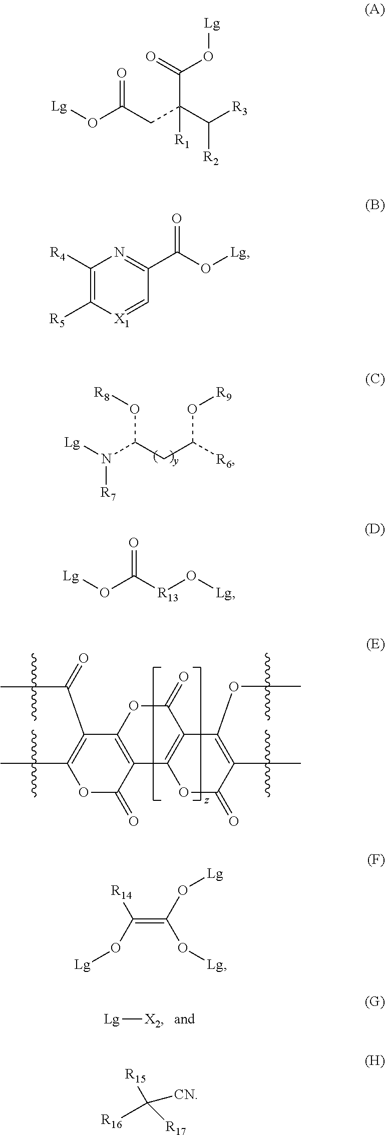

In some embodiments, [symbol] is selected from the group consisting of a single bond and a double bond; R₁ is selected from the group consisting of —H, —OLg and absent; each of R₂ and R₅ are independently selected from the group consisting of —H and —COOLg; R₃ is selected from the group consisting of —COOLg and —CH2COOLg, R₄ is selected from the group consisting of —H, —OLg and —COOLg; X1 is selected from the group consisting of C and N; R₆ is selected from the group consisting of —N(R₁₀)Lg, —OLg and —NLg; R₇ and R₁₀ are independently selected from the group consisting of —H, an aryl group, an alkyl group, -Lg and absent, each of R₈ and R₉ are independently selected from the group consisting of -Lg and absent; R₁₃ is selected from the group consisting of —CH₂—, —C(O)—, —C(CH₃)₂—, —CH₂C(O)—, —C(CH₃)₂CH₂—, —C(CH₃)₂C(O)—, (CHCH)_{w} C(O)—, —(CH₂CH₂)_{w}C(O)—, and —(C≡C)_{w}C(O)—; R₁₄ is selected from the group consisting of —H, —OLg, and —COOLg; each of R₁₅, R₁₆ and R₁₇ are independently selected from the group consisting of —H, —CN, an alkyl group and a cyanoalkyl group; X₂ is selected from the group consisting of —CN, —NCO, and —NCS; w is an integer in the range of 1 to 10; y is 0 or 1; z is an integer in the range of 1 to 100; and Lg is selected from the group consisting of trimethylsilyl (TMS) and toluenesulfonyl (CH₃C₆H₄SO₂).

In some embodiments, the electrolyte comprises at least two of Formula (A), Formula (B), Formula (C), Formula (D), Formula (F), Formula (G) or Formula (H). In some embodiments, the electrolyte is a salt form of at least one of Formula (A), Formula (B), Formula (C), Formula (D), Formula (F), Formula (G) and Formula (H). In further embodiments, the salt form of at least one of Formula (A), Formula (B), Formula (C), Formula (D), Formula (F), Formula (G) and Formula (H) is selected from the group consisting of a LiPF₆ salt form, LiBF₄ salt form, and LiDFOB salt form. In some embodiments, -Lg is TMS.

In some embodiments of the present disclosure, the electrolyte comprises Formula (A), or a salt thereof. In some embodiments, R₁ is —H. In other embodiments, R₂ is —COOLg. In some embodiments, R₃ is —COOLg. In some embodiments, the electrolyte comprises a salt form of Formula (A). In further embodiments, the salt form of Formula (A) is selected from the group consisting of

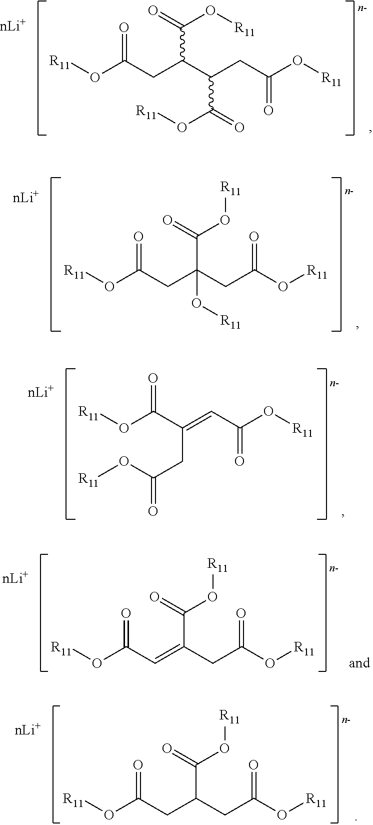

In some embodiments, R₁₁ is selected from the anionic group consisting of PF₆⁻¹, BF₄⁻¹, and difluoro(oxalato)borate (DFOB⁻). In some embodiments, n is the number of anionic groups.

In some embodiments, a compound of Formula (A), or a salt thereof, is selected from the group consisting of

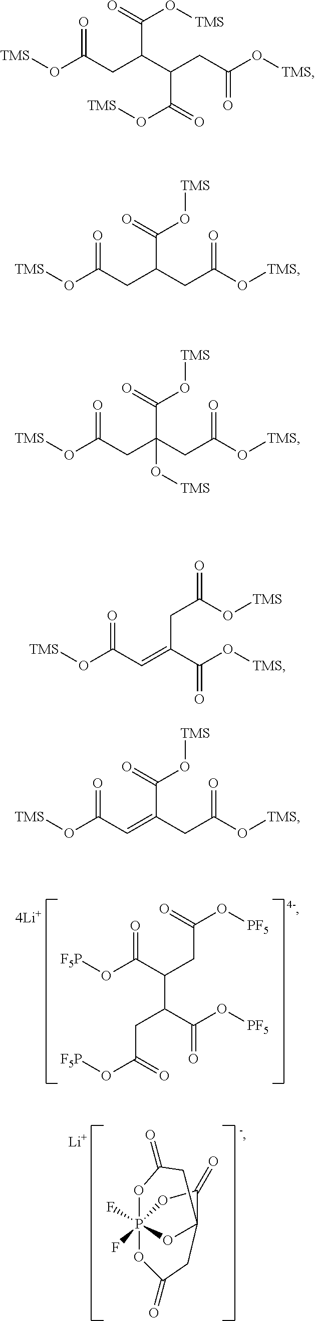

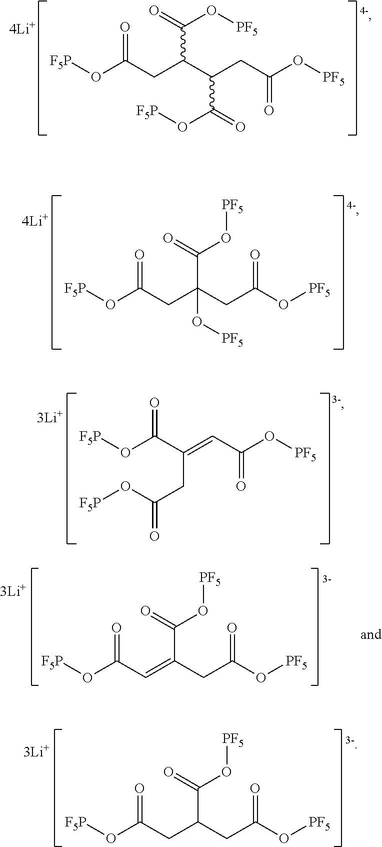

In some embodiments of the present disclosure, the electrolyte comprises Formula (B), or a salt thereof. In some embodiments, R₄ is —H. In some embodiments, R₅ is —COOLg. In other embodiments, X₁ is C. In further embodiments, a compound of Formula (B), or a salt thereof, is selected from the group consisting of

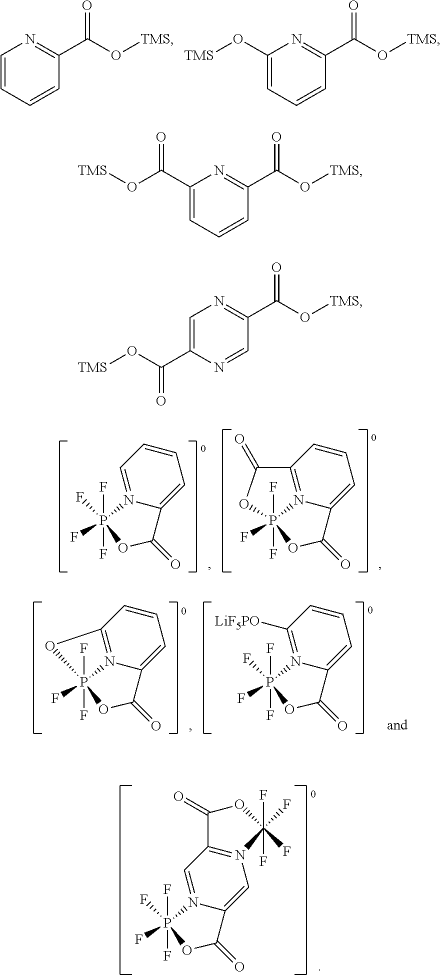

In some embodiments of the present disclosure, the electrolyte comprises Formula (C), or a salt thereof. In some embodiments, R₆ is —N(R₁₀)Lg. In some embodiments, R₁₀ is an alkyl group. In some embodiments, R₇ is —H. In other embodiments, R₈ is absent. In some embodiments, R₉ is -Lg. In some embodiments, y is 0. In further embodiments, a compound of Formula (C), or a salt thereof, is selected from the group consisting of

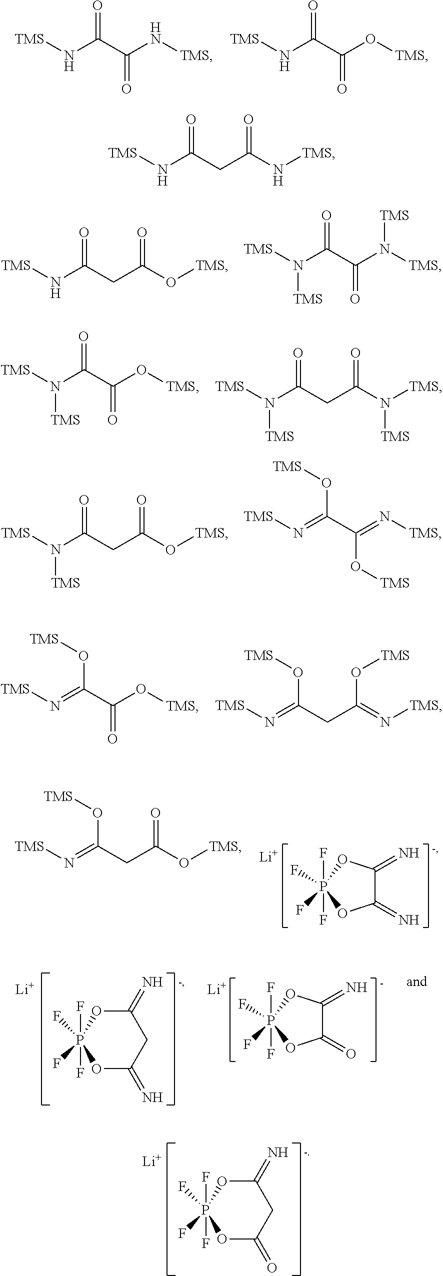

In some embodiments, a compound of Formula (C), or a salt thereof, is

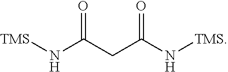 [SMILES: C[Si](C)(C)NC(=O)CC(=O)N[Si](C)(C)C]

In some embodiments of the present disclosure, the electrolyte comprises Formula (D), or a salt thereof. In some embodiments, R₁₃ is —CH₂C(O)—. In further embodiments, a compound of Formula (D), or a salt thereof, is selected from the group consisting of

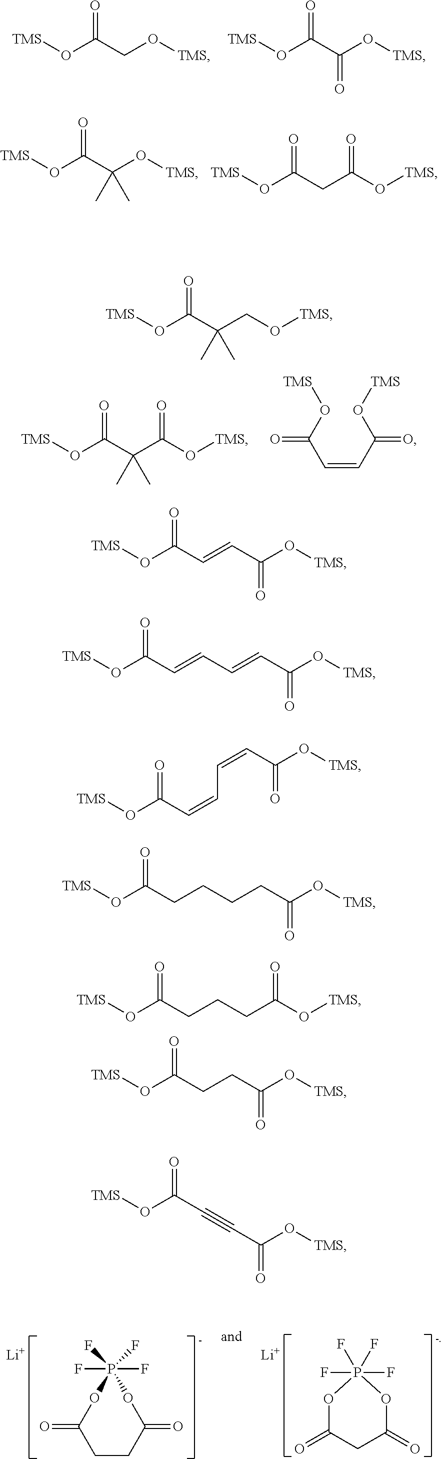

In some embodiments of the present disclosure, the polymeric component comprises a unit of Formula (E). In some embodiments, z is an integer in the range of 1 to 10.

In some embodiments of the present disclosure, the electrolyte comprises Formula (F), or a salt thereof. In some embodiments, R₄ is —H. In further embodiments, a compound of Formula (F), or a salt thereof, is selected from the group consisting of

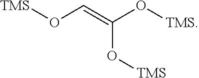 [SMILES: C[Si](C)(C)OC=C(O[Si](C)(C)C)O[Si](C)(C)C]

In some embodiments of the present disclosure, the electrolyte comprises Formula (G), or a salt thereof. In some embodiments, Lg is TMS. In some embodiments, Lg is toluenesulfonyl (CH₃C₆H₄SO₂). In some embodiments, X₂ is —CN. In some embodiments, X₂ is —NCO. In some embodiments, X₂ is —NCS. In further embodiments, a compound of Formula (G), or a salt thereof, is selected from the group consisting of TMS-CN, TMS-NCO, TMS-NCS,

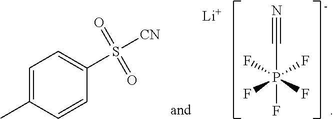

In some embodiments, a compound of Formula (G), or a salt thereof, is selected from the group consisting of TMS-CN and TMS-NCO.

In some embodiments of the present disclosure, the electrolyte comprises Formula (H), or a salt thereof. In some embodiments, R₁₅ is —H. In some embodiments, R₁₆ is a cyanoalkyl group. In some embodiments, R₁₇ is a cyanoalkyl group. In some embodiments, each of R₁₅, R₁₆ and R₁₇ are an alkyl group. In further embodiments, a compound of Formula (H), or a salt thereof, is selected from the group consisting of

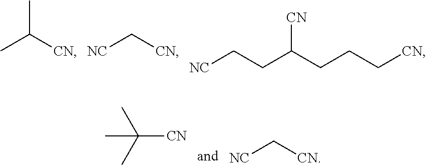

In some embodiments, a compound of Formula (H), or a salt thereof, is selected from the group consisting of

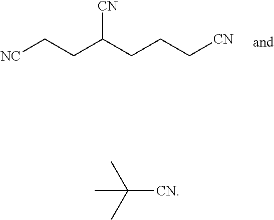

In some embodiments of the present disclosure, the electrolyte further comprises a solvent and a lithium salt.

Some embodiments of the present disclosure relate to an energy storage device, comprising: the electrolyte of the present disclosure; a cathode; an anode; and a housing, wherein the electrolyte, cathode and anode are disposed within the housing. In further embodiments, the energy storage device is a lithium-ion battery. In some embodiments, the energy storage device has a discharge capacity retention when cycled up to 4.4V of at least about 90% after 50 cycles.

Some embodiments of the present disclosure relate to a method of preparing an energy storage device, comprising: preparing the electrolyte of the present disclosure; and positioning the electrolyte within a housing comprising a cathode and an anode. In further embodiments, preparing comprises combining at least one of Formula (A), Formula (B), Formula (C), Formula (D), Formula (F), Formula (G), Formula (H) and the polymeric component that comprises a unit of Formula (E), or a salt thereof, the solvent and the lithium salt to form the electrolyte, and aging the electrolyte prior to positioning the electrolyte within the housing. In some embodiments, the electrolyte is aged for about 2-48 hours.

### BRIEF DESCRIPTION OF THE DRAWINGS

FIG. 1A is a bar chart showing the number of cycles to reach a capacity of 160 mAh/g for lithium-ion batteries with an electrolyte system comprising a compound according to some embodiments, relative to a baseline electrolyte system.

FIG. 1B is a bar chart showing the number of cycles to reach 90%/6 of the initial capacity for lithium-ion batteries with an electrolyte system comprising a compound according to some embodiments, relative to a baseline electrolyte system.

FIG. 2A is a line chart illustrating the passivation impact between 0.5 V to 4.5 V during the formation cycle of cells containing electrolyte systems comprising various amounts of additive c-D7 (also “S2-7”).

FIG. 2B is an expanded view of the line chart of FIG. 2A illustrating the passivation impact between 1.5 V to 3.5 V during the formation cycle of cells containing electrolyte systems comprising various amounts of additive c-D7 (also “S2-7”).

FIG. 3A is a bar chart showing discharge capacity vs. number of cycles of cells containing electrolyte systems comprising various amounts of additive c-D7 (also “S2-7”), relative to a baseline electrolyte system.

FIG. 3B is a bar chart showing average coulombic efficiency vs. number of formation cycles of cells containing electrolyte systems comprising various amounts of additive c-D7 (also “S2-7”), relative to a baseline electrolyte system.

FIG. 4 is a plot showing voltage vs. specific discharge capacity for cells containing electrolyte systems comprising various amounts of additive c-D7 (also “S2-7”).

FIG. 5A is a plot showing average specific discharge capacity as a function of cycle numbers for cells containing electrolyte systems comprising various amounts of additive c-D7 (also “S2-7”) at high voltage and high temperature.

FIG. 5B is a plot showing average coulombic efficiency as a function of cycle numbers for cells containing electrolyte systems comprising various amounts of additive c-D7 (also “S2-7”) at high voltage and high temperature.

FIG. 6A is a line chart illustrating the passivation impact between 0.5 V to 4.5 V during the formation cycle of cells containing electrolyte systems comprising various amounts of additive A4 (also “S3-2”).

FIG. 6B is an expanded view of the line chart of FIG. 6A illustrating the passivation impact between 1.5 V to 3.5 V during the formation cycle of cells containing electrolyte systems comprising various amounts of additive A4 (also “S3-2”).

FIG. 7A is a bar chart showing discharge capacity vs. number of cycles of cells containing electrolyte systems comprising various amounts of additive A4 (also “S3-2”), relative to a baseline electrolyte system.

FIG. 7B is a bar chart showing average coulombic efficiency vs. number of formation cycles of cells containing electrolyte systems comprising various amounts of additive A4 (also “S3-2”), relative to a baseline electrolyte system.

FIG. 8 is a plot showing voltage vs. specific discharge capacity for cells containing electrolyte systems comprising various amounts of additive A4 (also “S3-2”).

FIG. 9A is a plot showing average specific discharge capacity as a function of cycle numbers for cells containing electrolyte systems comprising various amounts of additive A4 (also “S3-2”).

FIG. 9B is a plot showing average coulombic efficiency as a function of cycle numbers for cells containing electrolyte systems comprising various amounts of additive A4 (also “S3-2”).

FIG. 10A is a plot showing average specific discharge capacity as a function of cycle numbers for cells containing electrolyte systems comprising various amounts of additive A1 (also “S4-1”).

FIG. 10B is a plot showing average coulombic efficiency as a function of cycle numbers for cells containing electrolyte systems comprising various amounts of additive A1 (also “S4-1”).

FIG. 11A is a plot showing average specific discharge capacity as a function of cycle numbers for cells containing electrolyte systems comprising various amounts of additive A3 (also “S4-2”).

FIG. 11B is a plot showing average coulombic efficiency as a function of cycle numbers for cells containing electrolyte systems comprising various amounts of additive A3 (also “S4-2”).

FIG. 12A is a plot showing average specific discharge capacity as a function of cycle numbers for cells containing electrolyte systems comprising various amounts of additive B1 (also “SP-1”).

FIG. 12B is a plot showing average coulombic efficiency as a function of cycle numbers for cells containing electrolyte systems comprising various amounts of additive B1 (also “SP-1”).

FIG. 13A is a plot showing average specific discharge capacity as a function of cycle numbers for cells containing electrolyte systems comprising various amounts of additive C3 (also “DA-1”).

FIG. 13B is a plot showing average coulombic efficiency as a function of cycle numbers for cells containing electrolyte systems comprising various amounts of additive C3 (also “DA-1”).

FIG. 14A is a plot showing average specific discharge capacity as a function of cycle numbers for cells with electrolyte systems comprising a compound according to some embodiments, relative to a baseline electrolyte system.

FIG. 14B is a plot showing average coulombic efficiency as a function of cycle numbers for cells with electrolyte systems comprising a compound according to some embodiments, relative to a baseline electrolyte system.

FIG. 15 is a plot showing discharge capacity as a function of cycle numbers for cells containing electrolyte systems comprising various amounts of additive G1 (also “N1-8”).

FIG. 16A shows ¹H NMR spectra of the conversion of additive A1 (also “S4-1”) to the final product in an electrolyte as a function of time.

FIG. 16B shows ¹⁹F NMR spectra of the conversion of additive A1 (also “S4-1”) to the final product in an electrolyte as a function of time.

FIG. 17 shows ¹⁹F NMR spectra of the conversion of additive A3 (also “S4-2”) to the final product in an electrolyte as a function of time.

FIG. 18 shows ¹⁹F NMR spectra of the conversion of additive B1 (also “SP-1”) to the final product in an electrolyte as a function of time.

FIG. 19A shows ¹H NMR spectra of the conversion of additive C3 (also “DA-1”) to the final product in an electrolyte as a function of time.

FIG. 19B shows ¹⁹F NMR spectra of the conversion of additive C3 (also “DA-1”) to the final product in an electrolyte as a function of time.

FIG. 20 shows ¹H NMR spectra of the conversion of additive c-D7 (also “S2-7”) to the final product in an electrolyte as a function of time.

FIG. 21 shows ¹⁹F NMR spectra of the conversion of additive D4 (also “S2-3”) to the final product in an electrolyte as a function of time.

FIG. 22A is a testing protocol used for electrolyte additives evaluation, according to one embodiment.

FIG. 22B is a testing protocol used for electrolyte additives evaluation, according to one embodiment.

FIG. 23 is a chart showing discharge capacity versus cycle number of lithium-ion batteries with an electrolyte system comprising an aged compound according to some embodiments relative to baseline electrolyte systems.

FIG. 24 is a chart showing discharge capacity and difference between average charge and discharge voltage versus cycle number of pouch cells with electrolyte systems comprising a compound according to some embodiments.

FIG. 25A is a chart showing discharge capacity versus cycle number of pouch cells with electrolyte systems comprising a compound according to some embodiments.

FIG. 25B is a chart showing the difference between average charge and discharge voltage versus cycle number of pouch cells with electrolyte systems comprising a compound according to some embodiments.

### DETAILED DESCRIPTION

Electrolyte formulations comprising at least one additive, or the salt thereof, for high-voltage, high-energy density energy storage devices (e.g., lithium ion batteries) are described. Such additives may react with lithium salts to improve device performances, such as stabilizing electrode surfaces. Such device improvements may beneficially afford improved cycling stability, particularly under extreme conditions such as high voltages (e.g., at least 4.4 V) and high temperature (e.g., about 40-45° C.).

### Definitions

As used herein, the term “alkyl” refers to a fully saturated aliphatic hydrocarbon group. The alkyl moiety may be branched or straight chain. Examples of branched alkyl groups include, but are not limited to, isopropyl, sec-butyl, t-butyl and the like. Examples of straight chain alkyl groups include, but are not limited to, methyl, ethyl, propyl, butyl, pentyl, hexyl, heptyl, and the like.

As used herein, “cycloalkyl” refers to a completely saturated (no double or triple bonds) mono- or multi-cyclic hydrocarbon ring system. When composed of two or more rings, the rings may be joined together in a fused fashion. Cycloalkyl groups can contain 3 to 10 atoms in the ring(s) or 3 to 8 atoms in the ring(s). A cycloalkyl group may be unsubstituted or substituted. Typical cycloalkyl groups include, but are in no way limited to, cyclopropyl, cyclobutyl, cyclopentyl, cyclohexyl, cycloheptyl and cyclooctyl.

As used herein, “cycloalkenyl” refers to a mono- or multi-cyclic hydrocarbon ring system that contains one or more double bonds in at least one ring; although, if there is more than one, the double bonds cannot form a fully delocalized pi-electron system throughout all the rings (otherwise the group would be “aryl,” as defined herein). When composed of two or more rings, the rings may be connected together in a fused fashion. A cycloalkenyl group may be unsubstituted or substituted.

As used herein, “cycloalkynyl” refers to a mono- or multi-cyclic hydrocarbon ring system that contains one or more triple bonds in at least one ring. If there is more than one triple bond, the triple bonds cannot form a fully delocalized pi-electron system throughout all the rings. When composed of two or more rings, the rings may be joined together in a fused fashion. A cycloalkynyl group may be unsubstituted or substituted.

The term “alkoxy” used herein refers to straight or branched chain alkyl radical covalently bonded to the parent molecule through an —O— linkage. Examples of alkoxy groups include, but are not limited to, methoxy, ethoxy, propoxy, isopropoxy, butoxy, n-butoxy, sec-butoxy, t-butoxy and the like.

The term “alkenyl” used herein refers to a monovalent straight or branched chain radical of from two to twenty carbon atoms containing a carbon double bond including, but not limited to, 1-propenyl, 2-propenyl, 2-methyl-1-propenyl, 1-butenyl, 2-butenyl, and the like.

The term “alkynyl” used herein refers to a monovalent straight or branched chain radical of from two to twenty carbon atoms containing a carbon triple bond including, but not limited to, 1-propynyl, 1-butynyl, 2-butynyl, and the like.

The term “aryl” used herein refers to homocyclic aromatic radical whether one ring or multiple fused rings. Moreover, the term “aryl” includes fused ring systems wherein at least two aryl rings, or at least one aryl and an ortho-fused bicyclic carbocyclic radical having about nine to ten ring atoms in which at least one ring is aromatic share at least one chemical bond. Examples of “aryl” rings include, but are not limited to, optionally substituted phenyl, biphenyl, naphthalenyl, phenanthrenyl, anthracenyl, tetralinyl, fluorenyl, indenyl, and indanyl.

The term, “heterocycle” or “heterocycle group” used herein refers to an optionally substituted monocyclic, bicyclic, or tricyclic ring system comprising at least one heteroatom in the ring system backbone. The heteroatoms are independently selected from oxygen, sulfur, and nitrogen. The term, “heterocycle” includes multiple fused ring systems. Moreover, the term “heterocycle” includes fused ring systems that may have any degree of saturation provided that at least one ring in the ring system is not aromatic. The monocyclic, bicyclic, or tricyclic ring system may be substituted or unsubstituted, and can be attached to other groups via any available valence, preferably any available carbon or nitrogen. Preferred monocyclic ring systems are of 4, 5, 6, 7, or 8 members. Six membered monocyclic rings contain from up to three heteroatoms wherein each heteroatom is individually selected from oxygen, sulfur, and nitrogen, and wherein when the ring is five membered, preferably it has one or two heteroatoms wherein each heteroatom is individually selected from oxygen, sulfur, and nitrogen. Preferred bicyclic cyclic ring systems are of 8 to 12 members and include spirocycles. An example of an optional substituent includes, but is not limited to, oxo (═O).

The term “heteroatom” used herein refers to, for example, oxygen, sulfur and nitrogen.

The term “amino” used herein refers to a nitrogen radical substituted with hydrogen, alkyl, aryl, or combinations thereof. Examples of amino groups include, but are not limited to, —NHMethyl, —NH₂, -Nmethyb, -NphenylMethyl, —NHPhenyl, -NethylMethyl, and the like.

The term “arylalkyl” used herein refers to one or more aryl groups appended to an alkyl radical. Examples of arylalkyl groups include, but are not limited to, benzyl, phenethyl, phenpropyl, phenbutyl, and the like.

The term “heteroarylalkyl” used herein refers to one or more heteroaryl groups appended to an alkyl radical. Examples of heteroarylalkyl include, but are not limited to, pyridylmethyl, furanylmethyl, thiopheneylethyl, and the like.

The term “aryloxy” used herein refers to an aryl radical covalently bonded to the parent molecule through an —O— linkage.

The term “carbonyl” used herein refers to C═O (i.e. carbon double bonded to oxygen).

The term “oxo” used herein refers to ═O (i.e. double bond to oxygen). For example, cyclohexane substituted with “oxo” is cyclohexanone.

The term “alkanoyl” used herein refers to a “carbonyl” substituted with an “alkyl” group, the “alkanoyl” group is covalently bonded to the parent molecule through the carbon of the “carbonyl” group. Examples of alkanoyl groups include, but are not limited to, methanoyl, ethanoyl, propanoyl, and the like. Methanoyl is commonly known as acetyl.

As used herein, “aryl” refers to a carbocyclic (all carbon) monocyclic or multicyclic aromatic ring system (including fused ring systems where two carbocyclic rings share a chemical bond) that has a fully delocalized pi-electron system throughout all the rings. The number of carbon atoms in an aryl group can vary. For example, the aryl group can be a C₆-C₁₄ aryl group, a C₆-C₁₀ aryl group, or a C₆ aryl group. Examples of aryl groups include, but are not limited to, benzene, naphthalene and azulene. An aryl group may be substituted or unsubstituted.

As used herein, “heteroaryl” refers to a monocyclic or multicyclic aromatic ring system (a ring system with fully delocalized pi-electron system) that contain(s) one or more heteroatoms, that is, an element other than carbon, including but not limited to, nitrogen, oxygen and sulfur. The number of atoms in the ring(s) of a heteroaryl group can vary. For example, the heteroaryl group can contain 4 to 14 atoms in the ring(s), 5 to 10 atoms in the ring(s) or 5 to 6 atoms in the ring(s). Furthermore, the term “heteroaryl” includes fused ring systems where two rings, such as at least one aryl ring and at least one heteroaryl ring, or at least two heteroaryl rings, share at least one chemical bond. Examples of heteroaryl rings include, but are not limited to, furan, furazan, thiophene, benzothiophene, phthalazine, pyrrole, oxazole, benzoxazole, 1,2,3-oxadiazole, 1,2,4-oxadiazole, thiazole, 1,2,3-thiadiazole, 1,2,4-thiadiazole, benzothiazole, imidazole, benzimidazole, indole, indazole, pyrazole, benzopyrazole, isoxazole, benzoisoxazole, isothiazole, triazole, benzotriazole, thiadiazole, tetrazole, pyridine, pyridazine, pyrimidine, pyrazine, purine, pteridine, quinoline, isoquinoline, quinazoline, quinoxaline, cinnoline, and triazine. A heteroaryl group may be substituted or unsubstituted.

As used herein, “heterocyclyl” or “heteroalicyclyl” refers to three-, four-, five-, six-, seven-, eight-, nine-, ten-, up to 18-membered monocyclic, bicyclic, and tricyclic ring system wherein carbon atoms together with from 1 to 5 heteroatoms constitute said ring system. A heterocycle may optionally contain one or more unsaturated bonds situated in such a way, however, that a fully delocalized pi-electron system does not occur throughout all the rings. The heteroatom(s) is an element other than carbon including, but not limited to, oxygen, sulfur, and nitrogen. A heterocycle may further contain one or more carbonyl or thiocarbonyl functionalities, so as to make the definition include oxo-systems and thio-systems such as lactams, lactones, cyclic imides, cyclic thioimides and cyclic carbamates. When composed of two or more rings, the rings may be joined together in a fused fashion. Additionally, any nitrogens in a heteroalicyclic may be quaternized. Heterocyclyl or heteroalicyclic groups may be unsubstituted or substituted. Examples of such “heterocyclyl” or “heteroalicyclyl” groups include but are not limited to, 1,3-dioxin, 1,3-dioxane, 1,4-dioxane, 1,2-dioxolane, 1,3-dioxolane, 1,4-dioxolane, 1,3-oxathiane, 1,4-oxathiin, 1,3-oxathiolane, 1,3-dithiole, 1,3-dithiolane, 1,4-oxathiane, tetrahydro-1,4-thiazine, 2H-1,2-oxazine, maleimide, succinimide, barbituric acid, thiobarbituric acid, dioxopiperazine, hydantoin, dihydrouracil, trioxane, hexahydro-1,3,5-triazine, imidazoline, imidazolidine, isoxazoline, isoxazolidine, oxazoline, oxazolidine, oxazolidinone, thiazoline, thiazolidine, morpholine, oxirane, piperidine N-Oxide, piperidine, piperazine, pyrrolidine, pyrrolidone, pyrrolidione, 4-piperidone, pyrazoline, pyrazolidine, 2-oxopyrrolidine, tetrahydropyran, 4H-pyran, tetrahydrothiopyran, thiamorpholine, thiamorpholine sulfoxide, thiamorpholine sulfone, and their benzo-fused analogs (e.g., benzimidazolidinone, tetrahydroquinoline, 3,4-methylenedioxyphenyl).

As used herein, “aralkyl” and “aryl(alkyl)” refer to an aryl group connected, as a substituent, via a lower alkylene group. The lower alkylene and aryl group of an aralkyl may be substituted or unsubstituted. Examples include but are not limited to benzyl, 2-phenylalkyl, 3-phenylalkyl, and naphthylalkyl.

As used herein, “heteroaralkyl” and “heteroaryl(alkyl)” refer to a heteroaryl group connected, as a substituent, via a lower alkylene group. The lower alkylene and heteroaryl group of heteroaralkyl may be substituted or unsubstituted. Examples include but are not limited to 2-thienylalkyl, 3-thienylalkyl, furylalkyl, thienylalkyl, pyrrolylalkyl, pyridylalkyl, isoxazolylalkyl, and imidazolylalkyl, and their benzo-fused analogs.

A “(heteroalicyclyl)alkyl” and “(heterocyclyl)alkyl” refer to a heterocyclic or a heteroalicyclylic group connected, as a substituent, via a lower alkylene group. The lower alkylene and heterocyclyl of a (heteroalicyclyl)alkyl may be substituted or unsubstituted. Examples include but are not limited tetrahydro-2H-pyran-4-yl)methyl, (piperidin-4-yl)ethyl, (piperidin-4-yl)propyl, (tetrahydro-2H-thiopyran-4-yl)methyl, and (1,3-thiazinan-4-yl)methyl.

“Lower alkylene groups” are straight-chained —CH₂— tethering groups, forming bonds to connect molecular fragments via their terminal carbon atoms. Examples include but are not limited to methylene (—CH₂—), ethylene (—CH₂CH₂—), propylene (—CH₂CH₂CH₂—), and butylene (—CH₂CH₂CH₂CH₂—). A lower alkylene group can be substituted by replacing one or more hydrogen of the lower alkylene group with a substituent(s) listed under the definition of “substituted.”

As used herein, “alkoxy” refers to the formula —OR wherein R is an alkyl, an alkenyl, an alkynyl, a cycloalkyl, a cycloalkenyl or a cycloalkynyl is defined as above. A non-limiting list of alkoxys are methoxy, ethoxy, n-propoxy, 1-methylethoxy (isopropoxy), n-butoxy, iso-butoxy, sec-butoxy and tert-butoxy. An alkoxy may be substituted or unsubstituted.

As used herein, “acyl” refers to a hydrogen, alkyl, alkenyl, alkynyl, aryl, or heteroaryl connected, as substituents, via a carbonyl group. Examples include formyl, acetyl, propanoyl, benzoyl, and acryl. An acyl may be substituted or unsubstituted.

As used herein, “acylalkyl” refers to an acyl connected, as a substituent, via a lower alkylene group. Examples include aryl-C(═O)—(CH₂)ₙ— and heteroaryl-C(═O)—(CH₂)ₙ—, where n is an integer in the range of 1 to 6.

As used herein, “alkoxyalkyl” refers to an alkoxy group connected, as a substituent, via a lower alkylene group. Examples include alkyl-O—(CH₂)ₙ—, wherein n is an integer in the range of 1 to 6.

As used herein, “aminoalkyl” refers to an optionally substituted amino group connected, as a substituent, via a lower alkylene group. Examples include H₂N—O—(CH₂)ₙ—, wherein n is an integer in the range of 1 to 6.

As used herein, “hydroxyalkyl” refers to an alkyl group in which one or more of the hydrogen atoms are replaced by a hydroxy group. Exemplary hydroxyalkyl groups include but are not limited to, 2-hydroxyethyl, 3-hydroxypropyl, 2-hydroxypropyl, and 2,2-dihydroxyethyl. A hydroxyalkyl may be substituted or unsubstituted.

As used herein, “haloalkyl” refers to an alkyl group in which one or more of the hydrogen atoms are replaced by a halogen (e.g., mono-haloalkyl, di-haloalkyl and tri-haloalkyl). Such groups include but are not limited to, chioromethyl, fluoromethyl, difluoromethyl, trifluoromethyl and 1-chloro-2-fluoromethyl, 2-fluoroisobutyl. A haloalkyl may be substituted or unsubstituted.

As used herein, “haloalkoxy” refers to an alkoxy group in which one or more of the hydrogen atoms are replaced by a halogen (e.g., mono-haloalkoxy, di-haloalkoxy and tri-haloalkoxy). Such groups include but are not limited to, chloromethoxy, fluoromethoxy, difluoromethoxy, trifluoromethoxy and 1-chloro-2-fluoromethoxy, 2-fluoroisobutoxy. A haloalkoxy may be substituted or unsubstituted.

As used herein, “aryloxy” and “arylthio” refers to RO- and RS-, in which R is an aryl, such as, but not limited to, phenyl. Both an aryloxy and arylthio may be substituted or unsubstituted.

As used herein, “alkylthio” refers to a “—SR” group, in which R is alkyl. Alkylthio may be substituted or unsubstituted.

As used herein, “cyanoalkyl” refers to an alkyl group substituted with one or more cyano (—CN) groups. Cyanoalkyl may be substituted or unsubstituted.

As used herein, a radical indicates species with a single, unpaired electron such that the species containing the radical can be covalently bonded to another species. Hence, in this context, a radical is not necessarily a free radical. Rather, a radical indicates a specific portion of a larger molecule. The term “radical” can be used interchangeably with the term “group.”

As used herein, “salt” refers to any material which is formed when a leaving group, or the hydrogen of an acid form, is replaced by a metal or its equivalent and which becomes ionized when dissolved in a solvent (e.g., water or a polar organic solvent) at the appropriate pKa.

### Additives

Some embodiments described herein generally relate to an electrolyte additive, or a salt thereof, selected from at least one of:

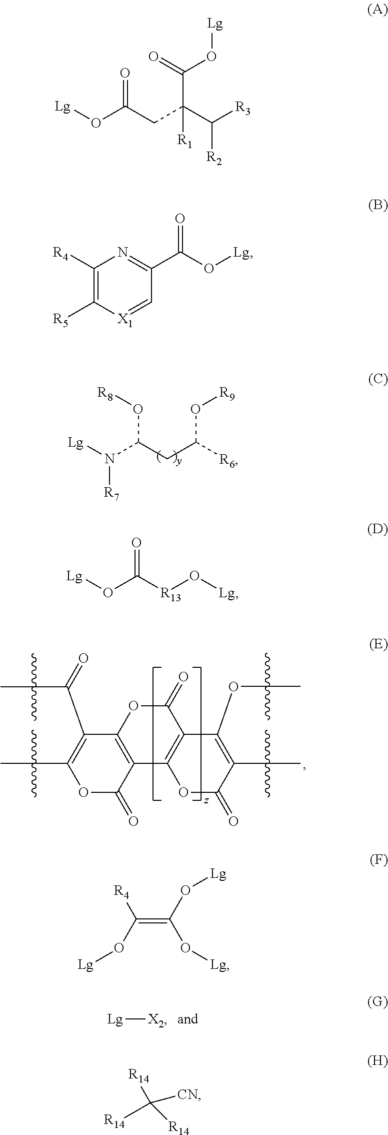

wherein: [symbol] is selected from a single bond and a double bond; R₁ is selected from —H, —OLg and absent; each of R₂ and R₅ are independently selected from —H and —COOLg; R₃ is selected from —COOLg and —CH₂COOLg; R₄ is selected from —H, —OLg and —COOLg; X₁ is selected from C and N; R₆ is selected from —N(R₁₀)Lg, —OLg and —NLg; R₇ and R₁₀ are independently selected from —H, an aryl group, an alkyl group, -Lg and absent; each of R₈ and R₉ are independently selected from -Lg and absent; R₁₃ is selected from —CH₂—, —C(O)—, —C(CH₃)₂—, —CH₂C(O)—, —C(CH₃)₂CH₂—, —C(CH₃)₂C(O)—, (CHCH)_{w}C(O)—, —(CH₂CH₂)_{w}C(O)—, and —(C↓C)_{w}C(O)—; R₁₄ is selected from the group consisting of —H, —OLg and —COOLg; each of R₁₅, R₁₆ and R₁₇ are independently selected from the group consisting of —H, —CN, an alkyl group and a cyanoalkyl group; X₂ is selected from the group consisting of —CN, —NCO, and —NCS; w is an integer in the range of 1 to 10; y is 0 or 1; z is an integer in the range of 1 to 100; and Lg is selected from trimethylsilyl (TMS) and toluenesulfonyl (CH₃C₆H₄SO₂).

### Formula (A)

In some embodiments, the electrolyte additive includes Formula (A), or a salt thereof, having the structure:

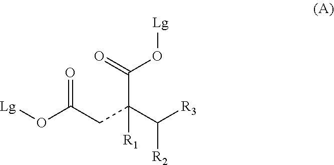

In some embodiments of Formula (A), [symbol] is selected from a single bond and a double bond, R₁ is selected from —H, —OLg and absent, R₂ is selected from —H and —COOLg, R₃ is selected from —COOLg and —CH₂COOLg, and Lg is selected from trimethylsilyl (TMS) and toluenesulfonyl (CH₃C₆H₄SO₂).

In some embodiments of Formula (A), [symbol] is selected from a single bond and a double bond. In any embodiment described herein, [symbol] is a single bond. In any embodiment described herein, [symbol] is a double bond.

In some embodiments of Formula (A), R₁ is selected from —H, —OLg and absent. In some embodiments, R₁ is —H. In some embodiments, R₁ is —OLg. In some embodiments, R₁ is absent.

In some embodiments of Formula (A), R₂ is selected from —H and —COOLg. In some embodiments, R₂ is —H. In some embodiments, R₂ is —COOLg.

In some embodiments of Formula (A), R₃ is selected from —COOLg and —CH₂COOLg. In some embodiments, R₃ is —COOLg. In some embodiments, R₃ is —CH₂COOLg.

In any embodiment described herein, Lg is selected from trimethylsilyl (TMS) and toluenesulfonyl (CH₃C₆H₄SO₂). In any embodiment described herein, each Lg is TMS.

In some embodiments, the electrolyte additive is a salt of Formula (A). In some embodiments, the salt form of Formula (A) has the structure:

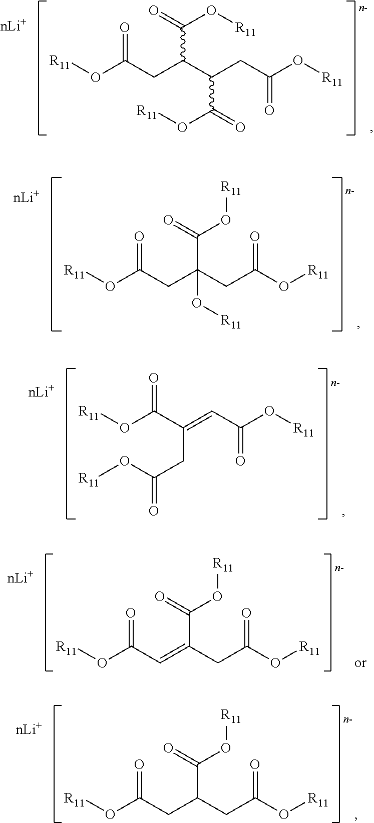

wherein: R₁₁ is selected from an anion of PF₆⁻¹, BF₄⁻¹, and difluoro(oxalato)borate (DFOB⁻); and n is the number of anionic groups. In some embodiments, the anionic group is PF₆⁻¹ In some embodiments, the anionic group is BF₄⁻¹. In some embodiments, the anionic group is (DFOB⁻).

In some embodiments, the electrolyte additive of Formula (A), or a salt thereof, is selected from the compounds shown in Table A.

TABLE A

| Name | Structure |
|---|---|
| A1 (also “S4-1”) | 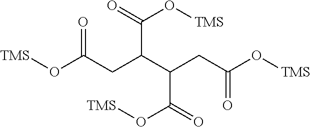 [SMILES: C[Si](C)(C)OC(=O)CC(C(=O)O[Si](C)(C)C)C(CC(=O)O[Si](C)(C)C)C(=O)O[Si](C)(C)C] |
| A2 (also “S3-3”) | 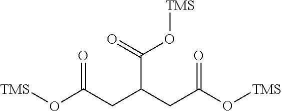 [SMILES: C[Si](C)(C)OC(=O)CC(CC(=O)O[Si](C)(C)C)C(=O)O[Si](C)(C)C] |
| A3 (also “S4-2”) | 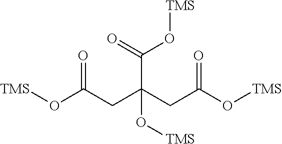 [SMILES: C[Si](C)(C)OC(=O)CC(CC(=O)O[Si](C)(C)C)(O[Si](C)(C)C)C(=O)O[Si](C)(C)C] |
| A4 (also “S3-2”) | 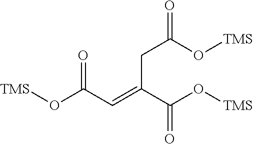 [SMILES: C[Si](C)(C)OC(=O)/C=C(\CC(=O)O[Si](C)(C)C)C(=O)O[Si](C)(C)C] |
| A5 | 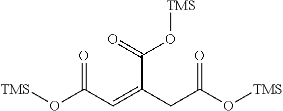 [SMILES: C[Si](C)(C)OC(=O)/C=C(/CC(=O)O[Si](C)(C)C)C(=O)O[Si](C)(C)C] |
| A6 | 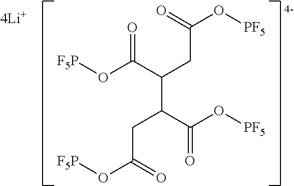 |
| A7 | 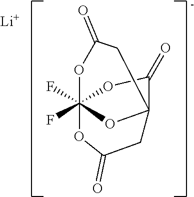 |
| A8 | 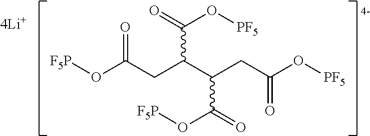 |
| A9 | 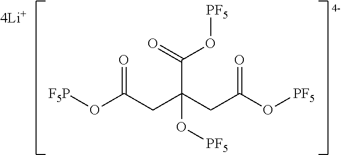 |
| A10 | 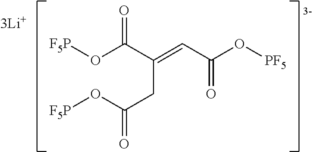 |
| A11 | 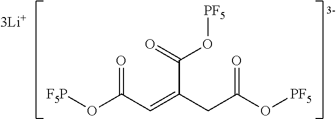 |
| A12 | 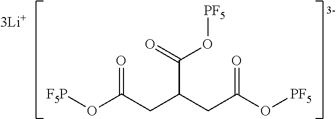 |

### Formula (B)

In some embodiments, the electrolyte additive includes Formula (B), or a salt thereof, having the structure:

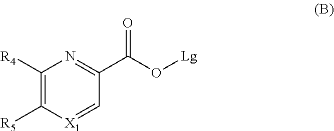

In some embodiments of Formula (B), R₄ is selected from —H, —OLg and —COOLg, R₅ is selected from —H and —COOLg, X₁ is selected from C and N, and Lg is selected from trimethylsilyl (TMS) and toluenesulfonyl (CH₃C₆H₄SO₂).

In some embodiments of Formula (B), R₄ is selected from —H, —OLg and —COOLg. In some embodiments, R₄ is —H. In some embodiments, R₄ is —OLg. In some embodiments, R₄ is —COOLg.

In some embodiments of Formula (B), R₅ is selected from —H and —COOLg. In some embodiments, R₅ is —H. In some embodiments, R₅ is —COOLg.

In some embodiments of Formula (B), X₁ is selected from C and N. In some embodiments, X₁ is C. In some embodiments, X₁ is N.

In some embodiments, the electrolyte additive of Formula (B), or a salt thereof, is selected from the compounds shown in Table B.

TABLE B

| Name | Structure |
|---|---|
| B1 (also “SP-1”) | 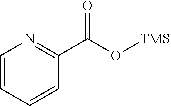 [SMILES: C[Si](C)(C)OC(=O)c1ccccn1] |
| B2 | 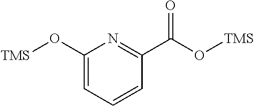 [SMILES: C[Si](C)(C)OC(=O)c1cccc(O[Si](C)(C)C)n1] |
| B3 (also “SP-2”) | 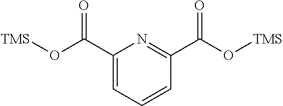 [SMILES: C[Si](C)(C)OC(=O)c1cccc(C(=O)O[Si](C)(C)C)n1] |
| B4 | 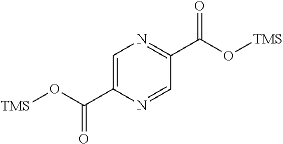 [SMILES: C[Si](C)(C)OC(=O)c1cnc(C(=O)O[Si](C)(C)C)cn1] |
| B5 | 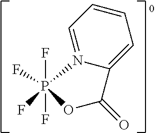 |
| B6 | 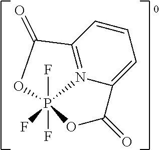 |
| B7 | 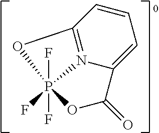 |
| B8 | 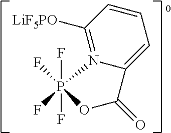 |
| B9 | 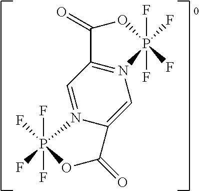 |

### Formula (C)

In some embodiments, the electrolyte additive includes Formula (C), or a salt thereof, having the structure:

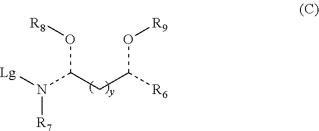

In some embodiments of Formula (C), [symbol] a is selected from the group consisting of a single bond and a double bond, R₆ is selected from —N(R₁₀)Lg, —OLg and —NLg, R₁₀ is selected from —H, an aryl group, an alkyl group, -Lg and absent, R₇ is selected from —H, an aryl group, an alkyl group, -Lg and absent, R₈ is selected from -Lg and absent. R₉ is selected from -Lg and absent, and y is 0 or 1, and Lg is selected from trimethylsilyl (TMS) and toluenesulfonyl (CH₃CH₄SO₂).

In some embodiments of Formula (C), R₆ is selected from —N(R₁₀)Lg, —OLg and —NLg. In some embodiments, R₆ is —N(R₁₀)Lg. In some embodiments, R₆ is —OLg. In some embodiments, R₆ is —NLg. In some embodiments of Formula (C), R₁₀ is selected from —H, an aryl group, an alkyl group, -Lg and absent. In some embodiments, R₁₀ is —H. In some embodiments, R₁₀ is an aryl group. In some embodiments, R₁₀ is an alkyl group. In some embodiments, R₁₀ is -Lg. In some embodiments, R₁₀ is absent.

In some embodiments of Formula (C), R₇ is selected from —H, an aryl group, an alkyl group, -Lg and absent. In some embodiments, R₇ is —H. In some embodiments, R₇ is an aryl group. In some embodiments, R₇ is an alkyl group. In some embodiments, R₇ is -Lg. In some embodiments, R₇ is absent.

In some embodiments of Formula (C), R₈ is selected from -Lg and absent. In some embodiments, R₈ is -Lg. In some embodiments, R₈ is absent.

In some embodiments of Formula (C), R is selected from -Lg and absent. In some embodiments, R₉ is -Lg. In some embodiments, R₉ is absent.

In some embodiments of Formula (C), y is 0 or 1. In some embodiments, y is 0. In some embodiments, y is 1.

In some embodiments, the electrolyte additive of Formula (C), or a salt thereof, is selected from the compounds shown in Table C.

TABLE C

| Name | Structure |
|---|---|
| C1 | 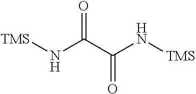 [SMILES: C[Si](C)(C)NC(=O)C(=O)N[Si](C)(C)C] |
| C2 | 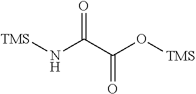 [SMILES: C[Si](C)(C)NC(=O)C(=O)O[Si](C)(C)C] |
| C3 (also “DA-1”) | 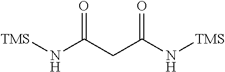 [SMILES: C[Si](C)(C)NC(=O)CC(=O)N[Si](C)(C)C] |
| C4 | 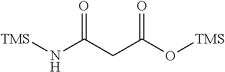 [SMILES: C[Si](C)(C)NC(=O)CC(=O)O[Si](C)(C)C] |
| C5 | 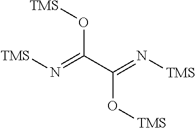 [SMILES: C[Si](C)(C)/N=C(O[Si](C)(C)C)/C(=N/[Si](C)(C)C)O[Si](C)(C)C] |
| C6 | 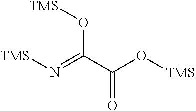 [SMILES: C[Si](C)(C)/N=C(\O[Si](C)(C)C)C(=O)O[Si](C)(C)C] |
| C7 | 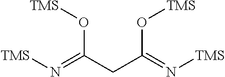 [SMILES: C[Si](C)(C)/N=C(/C/C(=N/[Si](C)(C)C)O[Si](C)(C)C)O[Si](C)(C)C] |
| C8 | 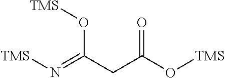 [SMILES: C[Si](C)(C)/N=C(/CC(=O)O[Si](C)(C)C)O[Si](C)(C)C] |
| C9 | 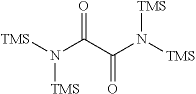 [SMILES: C[Si](C)(C)N(C(=O)C(=O)N([Si](C)(C)C)[Si](C)(C)C)[Si](C)(C)C] |
| C10 | 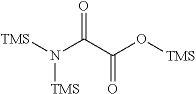 [SMILES: C[Si](C)(C)OC(=O)C(=O)N([Si](C)(C)C)[Si](C)(C)C] |
| C11 | 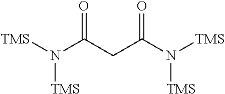 [SMILES: C[Si](C)(C)N(C(=O)CC(=O)N([Si](C)(C)C)[Si](C)(C)C)[Si](C)(C)C] |
| C12 | 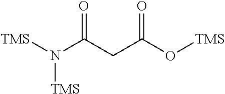 [SMILES: C[Si](C)(C)OC(=O)CC(=O)N([Si](C)(C)C)[Si](C)(C)C] |
| C13 | 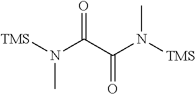 [SMILES: CN(C(=O)C(=O)N(C)[Si](C)(C)C)[Si](C)(C)C] |
| C14 | 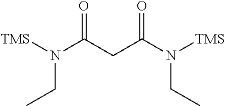 [SMILES: CCN(C(=O)CC(=O)N(CC)[Si](C)(C)C)[Si](C)(C)C] |
| C15 | 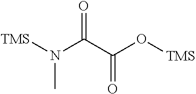 |
| C16 | 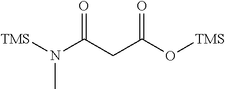 [SMILES: CN(C(=O)CC(=O)O[Si](C)(C)C)[Si](C)(C)C] |
| C17 | 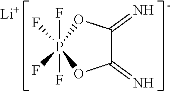 |
| C18 | 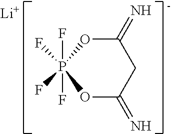 |
| C19 | 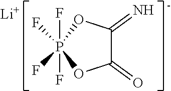 |
| C20 | 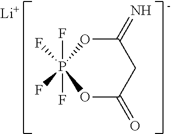 |

### Formula (D)

In some embodiments, the electrolyte additive includes Formula (D), or a salt thereof, having the structure:

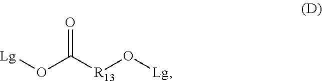

In some embodiments of Formula (D), R₁₃ is selected from —CH₂—, —C(O)—, —C(CH₃)₂—, —CH₂C(O)—, —C(CH₃)₂CH₂—, —C(CH₃)₂C(O)—, —(CHCH)_{w}C(O)—, —(CH₂CH₂)_{w}C(O)—, and —(C≡C)_{w}C(O)—, and Lg is selected from trimethylsilyl (TMS) and toluenesulfonyl (CH₃C₆H₄SO₂).

In some embodiments, R₁₃ is —CH₂—. In some embodiments, R₁₃ is —C(O)—. In some embodiments, R₁₃ is —C(CH₃)₂—. In some embodiments, R₁₃ is —CH₂C(O)—. In some embodiments, R₁₃ is —C(CH₃)₂CH₂—. In some embodiments, R₃ is —C(CH₃)₂C(O)—. In some embodiments, R₁₃ is —(CHCHC(O). In some embodiments, R₁₃ is —(CHCH)_{w}C(O)—. In some embodiments, R₁₃ is —(CH₂CH₂)_{w}C(O)—. In some embodiments, R₁₃ is —(C≡C)_{w}C(O)—. In some embodiments, w is an integer in the range of 1 to 10.

In some embodiments, the electrolyte additive of Formula (D), or a salt thereof, is selected from the compounds shown in Table D.

TABLE D

| Name | Structure |
|---|---|
| D1 (also “S2-4”) | 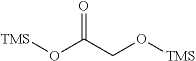 [SMILES: C[Si](C)(C)OCC(=O)O[Si](C)(C)C] |
| D2 (also “S2-1”) | 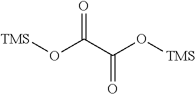 [SMILES: C[Si](C)(C)OC(=O)C(=O)O[Si](C)(C)C] |
| D3 (also “S2-6”) | 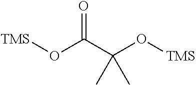 |
| D4 (also “S2-3” or bis(trimethylsilyl) malonate or “bTMSM”) | 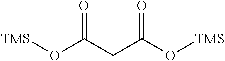 [SMILES: C[Si](C)(C)OC(=O)CC(=O)O[Si](C)(C)C] |
| D5 | 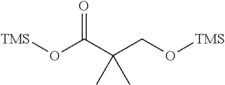 [SMILES: CC(C)(CO[Si](C)(C)C)C(=O)O[Si](C)(C)C] |
| D6 (also “S2-5”) | 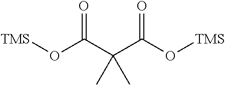 [SMILES: CC(C)(C(=O)O[Si](C)(C)C)C(=O)O[Si](C)(C)C] |
| c-D7 (also “S2-7”) | 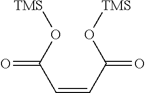 [SMILES: C[Si](C)(C)OC(=O)/C=C\C(=O)O[Si](C)(C)C] |
| t-D7 | 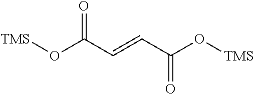 [SMILES: C[Si](C)(C)OC(=O)/C=C/C(=O)O[Si](C)(C)C] |
| t-D8 | 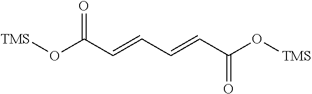 [SMILES: C[Si](C)(C)OC(=O)/C=C/C=C/C(=O)O[Si](C)(C)C] |
| c-D8 | 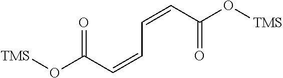 [SMILES: C[Si](C)(C)OC(=O)/C=C\C=C/C(=O)O[Si](C)(C)C] |
| D9 | 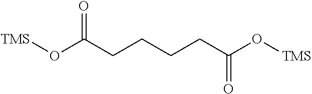 [SMILES: C[Si](C)(C)OC(=O)CCCCC(=O)O[Si](C)(C)C] |
| D10 | 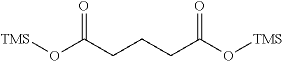 [SMILES: C[Si](C)(C)OC(=O)CCCC(=O)O[Si](C)(C)C] |
| D11 | 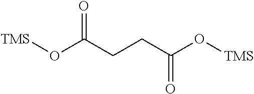 [SMILES: C[Si](C)(C)OC(=O)CCC(=O)O[Si](C)(C)C] |
| D12 | 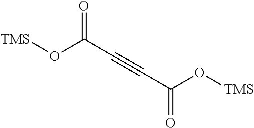 [SMILES: C[Si](C)(C)OC(=O)C#CC(=O)O[Si](C)(C)C] |
| D13 | 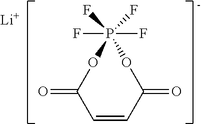 |
| D14 | 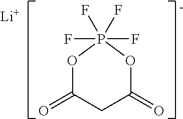 |

In some embodiments, the electrolyte additive cannot be one or more of the following compounds, or a salt thereof.

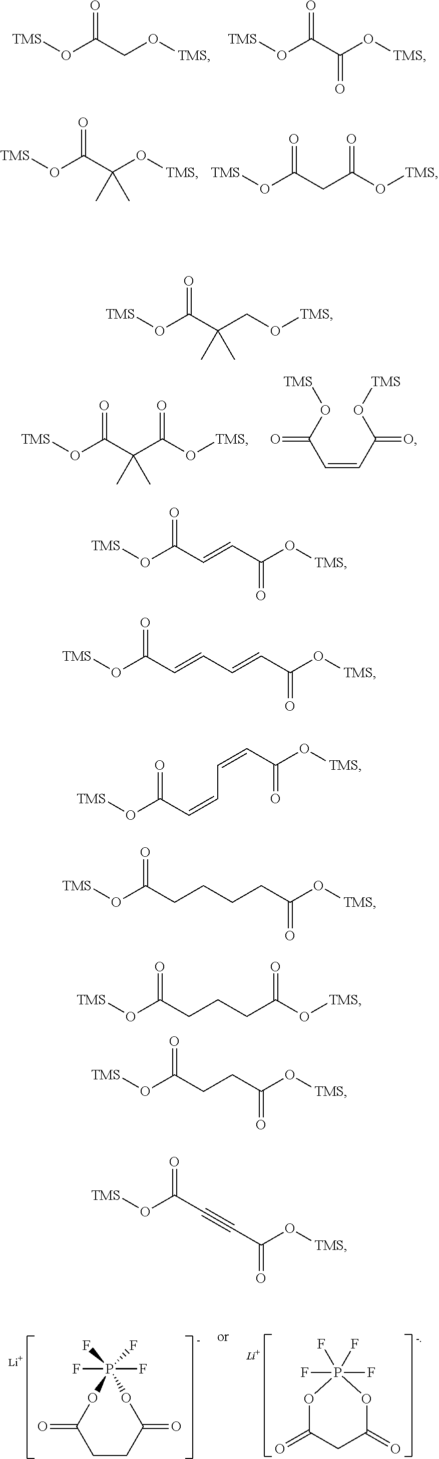

### Formula (E)

In some embodiments, the electrolyte additive can be a polymeric component that comprises a unit of Formula (E), having the structure:

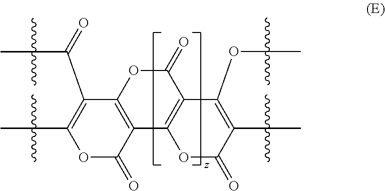

wherein z is an integer in the range of 1 to 100. In some embodiments of Formula (E), z is an integer in the range of 1 to 10. In some embodiments, z is an integer in the range of 5 to 15. In some embodiments, z is an integer in the range of 1 to 20.

### Formula (F)

In some embodiments, the electrolyte additive includes Formula (F), or a salt thereof, having the structure:

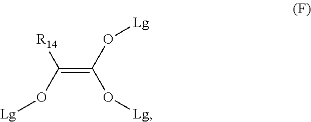

In some embodiments of Formula (F), R₁₄ is selected from —H, —OLg and —COOLg, and Lg is selected from trimethylsilyl (TMS) and toluenesulfonyl (CH₃C₆H₄SO₂).

In some embodiments, R₁₄ is —H. In some embodiments, R₁₄ is —OLg. In some embodiments, R₁₄ is —COOLg.

In some embodiments, the electrolyte additive of Formula (F), or a salt thereof, is selected from the compounds shown in Table E.

TABLE E

| Name | Structure |
|---|---|
| F1 | 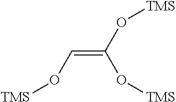 [SMILES: C[Si](C)(C)OC=C(O[Si](C)(C)C)O[Si](C)(C)C] |
| F2 | 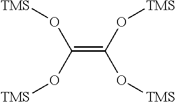 [SMILES: C[Si](C)(C)OC(O[Si](C)(C)C)=C(O[Si](C)(C)C)O[Si](C)(C)C] |
| F3 | 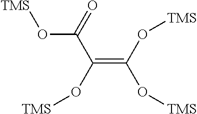 [SMILES: C[Si](C)(C)OC(=O)C(O[Si](C)(C)C)=C(O[Si](C)(C)C)O[Si](C)(C)C] |

### Formula (G)

In some embodiments, the electrolyte additive includes Formula (G), or a salt thereof, having the structure:

Lg-X₂ (G)

In some embodiments of Formula (G), X₂ is selected from the group consisting of —CN, —NCO, and —NCS, and Lg is selected from trimethylsilyl (TMS) and toluenesulfonyl (CH₃C₆H₄SO₂).

In some embodiments, X₂ is —CN. In some embodiments, X₂ is —NCO. In some embodiments, X₂ is —NCS.

In some embodiments, the electrolyte additive of Formula (G), or a salt thereof, is selected from the compounds shown in Table F.

TABLE F

| Name | Structure |
|---|---|
| G1 | TMS—CN |
| (also “N1-8”) | |
| G2 | TMS—NCO |
| (also “S1-5”) | |
| G3 | TMS—NCS |
| (also “S1-6”) | |
| G4 | 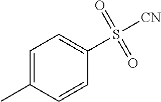 |
| G5 | 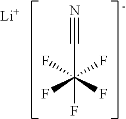 |

### Formula (H)

In some embodiments, the electrolyte additive includes Formula (H), or a salt thereof, having the structure:

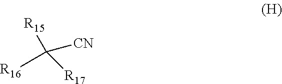

In some embodiments of Formula (H), each of R₁₅, R₁₆ and R₁₇ are independently selected from the group consisting of —H, —CN, an alkyl group, and a cyanoalkyl group.

In some embodiments, R₁₅ is —H. In some embodiments, R₁₅ is —CN. In some embodiments, R₁₅ is an alkyl group. In some embodiments, R₁₅ is a cyanoalkyl group. In some embodiments, R₁₆ is —H. In some embodiments, R₁₆ is —CN. In some embodiments, R₁₆ is an alkyl group. In some embodiments, R₁₆ is a cyanoalkyl group. In some embodiments, R₁₇ is —H. In some embodiments, R₁₇ is —CN. In some embodiments, R₁₇ is an alkyl group. In some embodiments, R₁₇ is a cyanoalkyl group. In some embodiments, each of R₁₅, R₁₆ and R₁₇ are an alkyl group.

In some embodiments, cyanoalkyl groups include a linear cyanoalkyl group and a branched cyanoalkyl group. In some embodiments, a cyanoalkyl group includes —CH₂CN, —CH₂CH₂CN, —CH(CH₃)CN, —C(CH₃)₂CN, —CH(CH₂CH)CN, —C(CH₂CH₃)₂CN.

In some embodiments, the electrolyte additive of Formula (H), or a salt thereof, is selected from the compounds shown in Table G.

TABLE G

| Name | Structure |
|---|---|
| H1 | 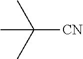 |
| H2 (also “N3-2” or 1,3,6- hexanetricarbonitrile or HTCN) | 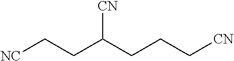 [SMILES: N#CCCCC(C#N)CCC#N] |
| H3 | 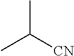 |
| H4 | 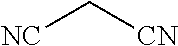 |
| H5 | 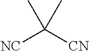 |

### Electrolytes

The electrolyte formulations described herein can include a lithium salt, an electrolyte solvent, and one or more of the additives discussed herein. In some embodiments, the electrolyte further comprises one or more additional additives. In some embodiments, the electrolyte comprises the additive in, in about, in at most, or in at most about, 0.1 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 7 wt. % or 8 wt. %, or any range of values therebetween. In some embodiments, the electrolyte comprises a plurality of additives that total to, to about, to at most, or to at most about, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, 10 wt. %, 11 wt. % or 12 wt. %, or any range of values therebetween.

Generally, the lithium salt comprises a cation and an anion. In some embodiments, the anion is redox stable. In some embodiments, the anion can be monovalent. In some embodiments, a lithium salt can be selected from lithium hexafluorophosphate (LiPF₆), lithium tetrafluoroborate (LiBF₄), lithium difluoro(oxalato)borate (LiDFOB) and combinations thereof. In some embodiments, the electrolyte can include an anion selected from hexafluorophosphate, tetrafluoroborate, and difluoro(oxalato)borate. In certain embodiments, the salt concentration of the electrolyte can be, be about, be at most, or be at most about, 0.1 M, 0.2 M, 0.3 M, 0.4 M, 0.5 M, 0.6 M, 0.7 M, 0.8 M, 0.9 M, 1 M, 1.1 M, 1.2 M, 1.3 M, 1.4 M, 1.5 M, 1.6 M, 1.7 M, 1.8 M, 1.9 M, 2 M, 2.1 M, 2.2 M, 2.3 M, 2.4 M, 2.5 M, 2.6M, 2.7M, 2.8M, 2.9M, 3M, 3.1 M, 3.2M, 3.3 M, 3.4M, 3.5 M, 3.6M, 3.7M, 3.8 M, 3.9 M, 4 M, 4.1 M, 4.2 M, 4.3 M, 4.4 M, 4.5 M, 4.6 M, 4.7 M, 4.8 M, 4.9 M, 5 M, 5.1 M, 5.2M, 5.3M, 5.4M, 5.5M, 5.6M, 5.7M, 5.8M, 5.9M, 6M, 6.1 M, 6.2M, 6.3M, 6.4M, 6.5 M, 6.6 M, 6.7 M, 6.8 M, 6.9 M, or 7 M, or any range of values therebetween. For example, in some embodiments, the salt concentration can be about 0.1 M to about 5 M, about 0.2 M to about 3 M, about 0.3 M to about 2 M, or about 0.7 M to about 1 M.

In some embodiments, the electrolyte includes a liquid solvent. A solvent as provided herein need not dissolve every component, and need not completely dissolve each component of the electrolyte. In further embodiments, the solvent can include an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In some embodiments, the solvent can comprise methyl acetate. In some embodiments, the electrolyte comprises the solvent in, in about, in at least, or in at least about, 80 wt. %, 81 wt. %, 82 wt. %, 83 wt. %, 84 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. % or 98 wt. %, or any range of values therebetween.

### Energy Storage Device

Energy storage devices of the present disclosure include the electrolyte discussed herein, a cathode, an anode, and a housing, wherein the electrolyte, cathode and anode are disposed within the housing. In some embodiments, an energy storage device as provided herein is a lithium-ion battery. In some embodiments, an energy storage device as provided herein has a discharge capacity retention when cycled up to 4.4V of at least about 90% after 50 cycles. Each of the cathode and anode include an electrode film and a current collected that form the electrode.

In some embodiments, an electrode film as provided herein includes at least one active material. In some embodiments, the electrode film further comprises at least one binder.

In some embodiments, an electrode film includes an anode active material. In some embodiments, anode active materials can include, for example, an insertion material (such as carbon or graphite), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si-SiOx, Sn-SnOx, Si-SiOx-C, Sn-SnOx-C, Si—Sn—C, SiOx-SnOx-C, Si-SiOx-Sn, or Sn-SiOx-SnOx). Anode active materials include common natural graphite, synthetic or artificial graphite, surface modified graphite, spherical-shaped graphite, flake-shaped graphite and blends or combinations of these types of graphite, metallic elements and its compound as well as metal-C composite for anode.

In some embodiments, an electrode film includes active cathode material. In some embodiments, cathode active materials can comprise, for example, a metal oxide, metal sulfide, or a lithium metal oxide. The lithium metal oxide can be, for example, a lithium nickel manganese cobalt oxide (NMC), a lithium manganese oxide (LMO), a lithium iron phosphate (LFP), a lithium cobalt oxide (LCO), a lithium titanate (LTO), and/or a lithium nickel cobalt aluminum oxide (NCA). In some embodiments, cathode active materials can comprise, for example, a layered transition metal oxide (such as LiCoO2 (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)), an olivine (such as LiFePO₄), silicon, silicon oxide (SiOx), aluminum, tin, tin oxide (SnOx), manganese oxide (MnOx), molybdenum oxide (MoO₂), molybdenum disulfide (MoS₂), nickel oxide (NiOx), or copper oxide (CuOx). The cathode active material can comprise sulfur or a material including sulfur, such as lithium sulfide (Li₂S), or other sulfur-based materials, or a mixture thereof.

An energy storage device as provided herein can be of any suitable configuration, for example planar, spirally wound, button shaped, or pouch. An energy storage device as provided herein can be a component of a system, for example, a power generation system, an uninterruptible power source systems (UPS), a photo voltaic power generation system, an energy recovery system for use in, for example, industrial machinery and/or transportation. An energy storage device as provided herein may be used to power various electronic device and/or motor vehicles, including hybrid electric vehicles (HEV), plug-in hybrid electric vehicles (PHEV), and/or electric vehicles (EV).

In some embodiments, an energy storage device including an electrolyte formulation as provided herein may demonstrate a higher discharge rate capability in comparison to energy storage devices that do not use the electrolyte formulations described herein. Such higher discharge rate capability is desirable in high energy, high power applications such as electric vehicle propulsion.

An energy storage device including an electrolyte formulation described herein may be characterized by improved capacity retention over the life of the device. Further improvements that may be realized in various embodiments include improved cycling performance, including improved storage stability during cycling and reduced capacity fade. In some embodiments, improved cycling performance were also achieved under aggressive or stressed conditions (e.g., long constant voltage hold at 4.4V)

It will be understood that an electrolyte formulation provided herein, can be used in various embodiments with any of a number of energy storage devices and systems, such as one or more batteries, capacitors, capacitor-battery hybrids, fuel cells, or other energy storage systems or devices and combinations thereof. In some embodiments, an electrolyte additive or electrolyte including an additive described herein may be implemented in lithium ion batteries.

In some embodiments, the lithium ion battery is configured to operate at about 2.5 to 4.5 V, or 3.0 to 4.2 V. In further embodiments, the lithium ion battery is configured to have a minimum operating voltage of about 2.5 V to about 3 V, respectively. In still further embodiments, the lithium ion battery is configured to have a maximum operating voltage of about 4.1 V to about 4.4 V, respectively.

### Methods of Preparing

Additives, electrolytes and energy storage devices discussed herein may be synthesized or manufactured. In some embodiments, a method for preparing an energy storage device includes preparing the electrolyte discussed herein and positioning the electrolyte within a housing comprising a cathode and an anode. In some embodiments, a method for preparing an electrolyte includes combining at least one of Formula (A), Formula (B), Formula (C), Formula (D), Formula (F), Formula (G), Formula (H) and the polymeric component that comprises a unit of Formula (E), or a salt thereof, the solvent and the lithium salt to form the electrolyte.

### Aging

Some embodiments of the present disclosure relate to aging the electrolyte prior to positioning the electrolyte within the housing. In some embodiments, the electrolyte is aged for, for about, for at least, or for at least about 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, 31 hours, 32 hours, 33 hours, 34 hours, 35 hours, 36 hours, 37 hours, 38 hours, 39 hours, 40 hours, 41 hours, 42 hours, 43 hours, 44 hours, 45 hours, 46 hours, 47 hours, 48 hours, 3 days, 4 days, 5 days, 6 days, 7 days, 2 weeks, 3 weeks, 4 weeks, 5 weeks, 6 weeks, or any range of values therebetween. For example, in some embodiments the electrolyte is aged for about 2 hours to about 48 hours, about 7 days to about 2 weeks, or 2 weeks to about 3 weeks.

### EXAMPLES

Example embodiments of the present disclosure, including processes, materials and/or resultant products, are described in the following examples.

### Example 1—Coin Cell Specifications

Electrolyte additives were tested for their efficacy in NMC532 coin cells. Coin cells were manufactured and vacuum sealed in a dry room without electrolyte. Table 1 summarizes the specifications of the coin cells.

TABLE 1
NMC532 Coin Cell Specifications

| | Positive Electrode | Negative Electrode |
|---|---|---|
| Material | Li[Ni_{0.5}Mn_{0.3}Co_{0.2}]O₂ | Artificial Graphite |
| Active Area (cm²) | 1.54 | 1.77 |
| Electrode thickness (μm) | 54 | 55 |
| Loading (mg/cm²) | 9.13 | 6.38 |
| Active material percentage | 90 | 91.83 |
| Max. Charge Voltage | 3.0-4.5 V (Half-cell) | 0.005-1.5 V (Half-cell) |
| Typical Charge Voltage | 3.0-4.4 V (Full cell) | N/A |
| Specific Capacity to 4.4 V at C/10 | 198 | 330 |
| Capacity to 4.4 V at 1C | 180 | 320 |

1 M or 1.5 M LiPF₆ in 25:5:70 weight ratio EC:EMC:DMC with 0.7 wt. % fluoroethylene carbonate (FEC) and 0.25 wt. % vinylene carbonate (VC) was used as the control electrolyte (“baseline”). Electrolytes according to the baseline electrolyte, with and without FEC and/or VC, but with various amounts of additives disclosed herein were also prepared, and described in the Examples below.

### Example 2—Coin-Cell Screening

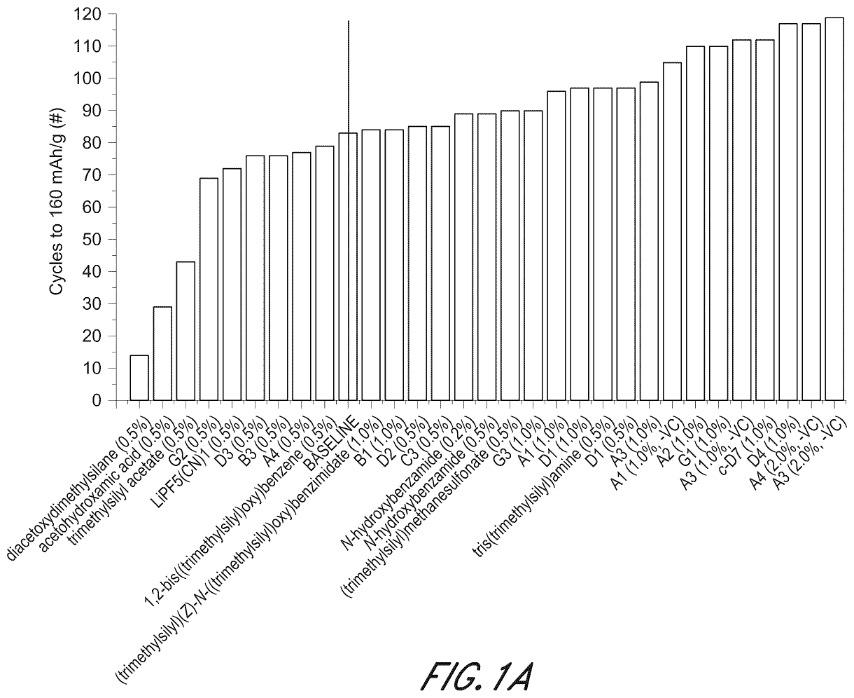

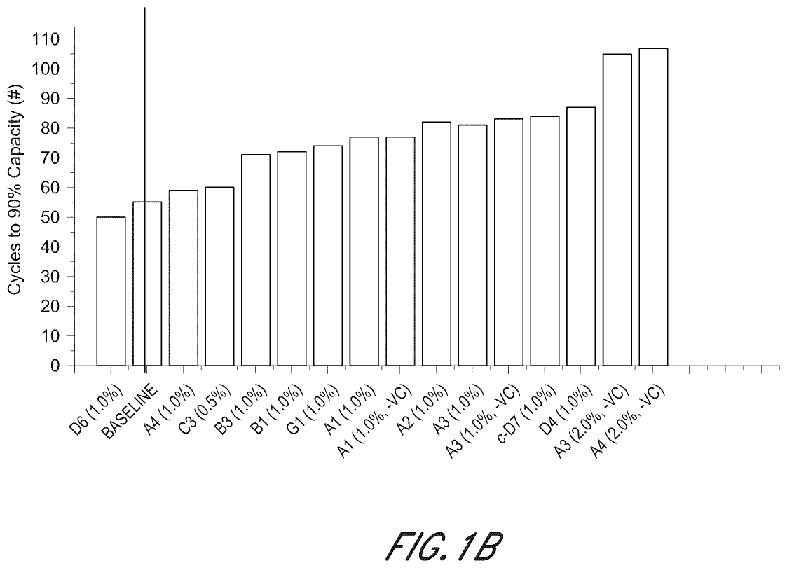

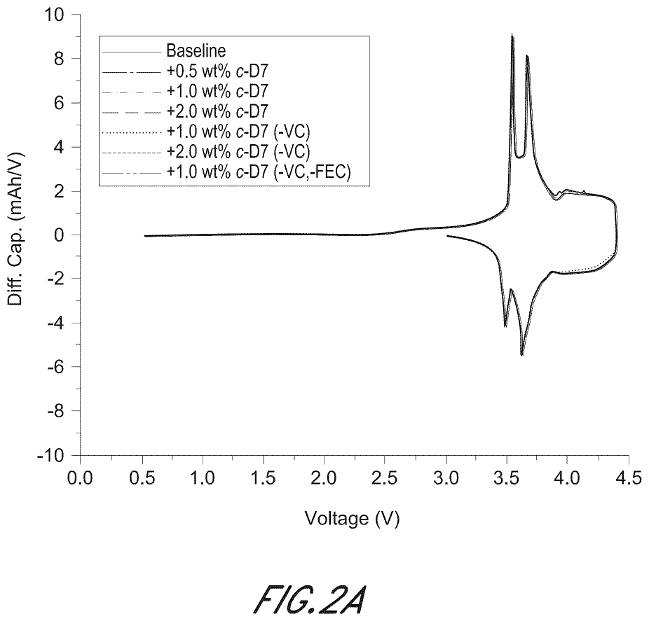

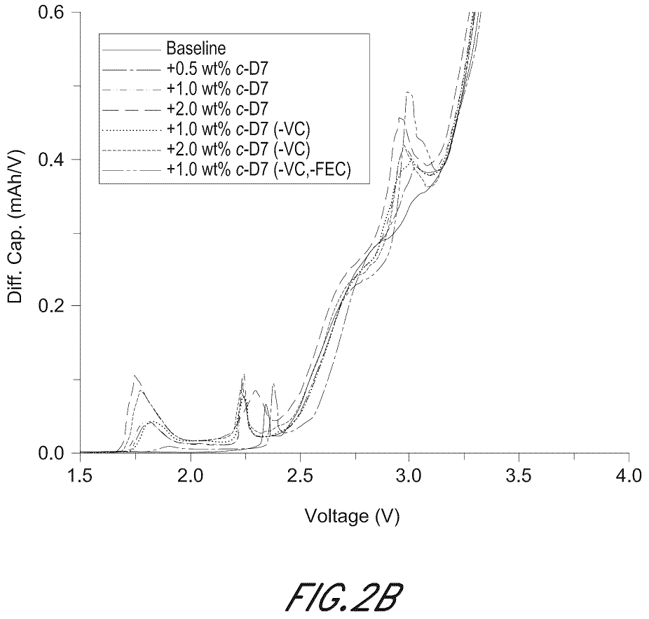

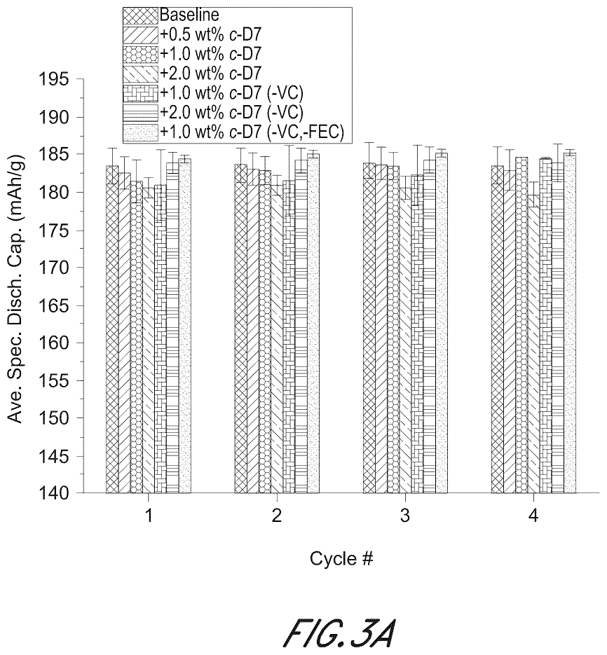

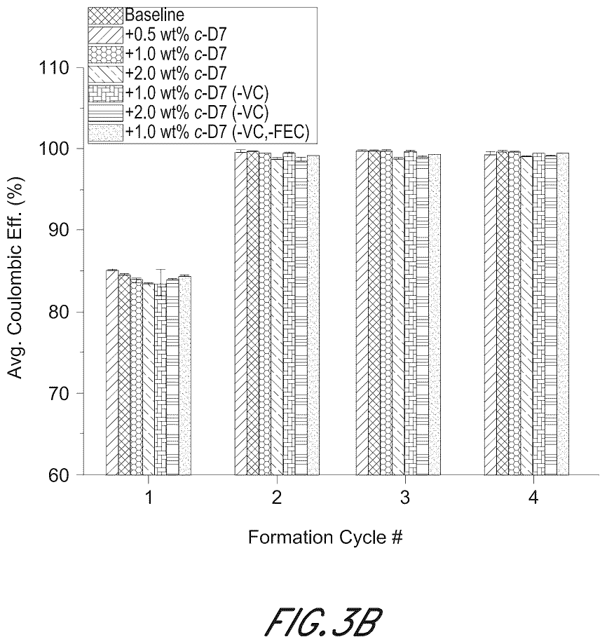

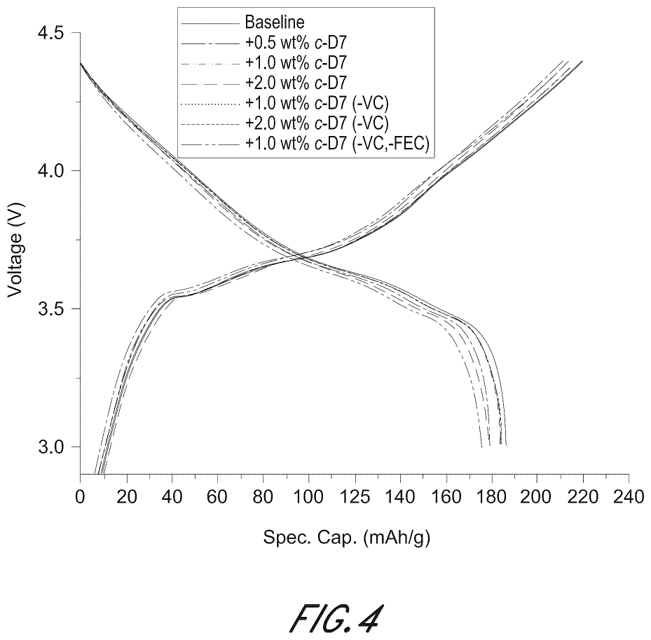

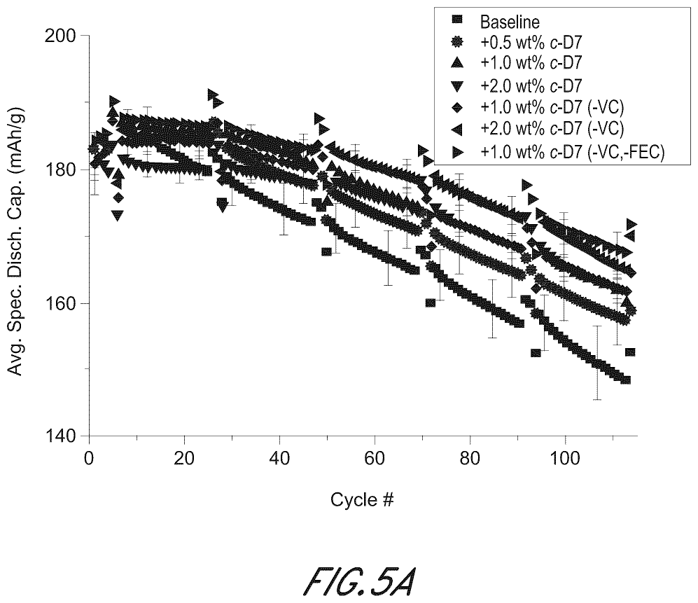

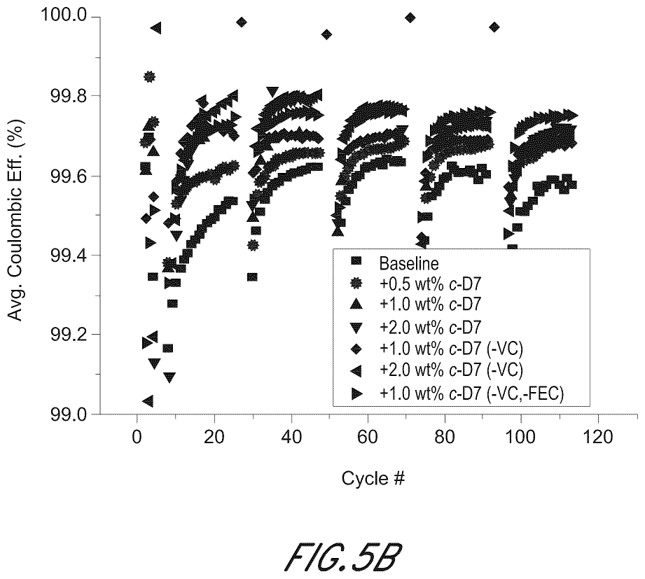

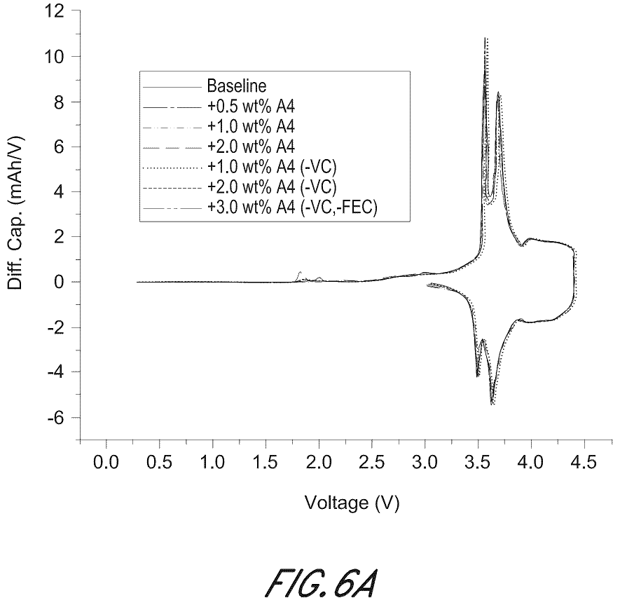

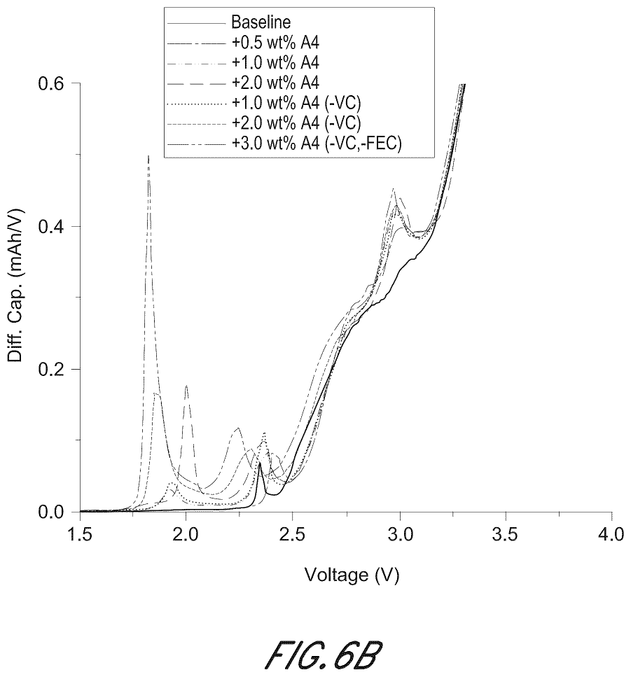

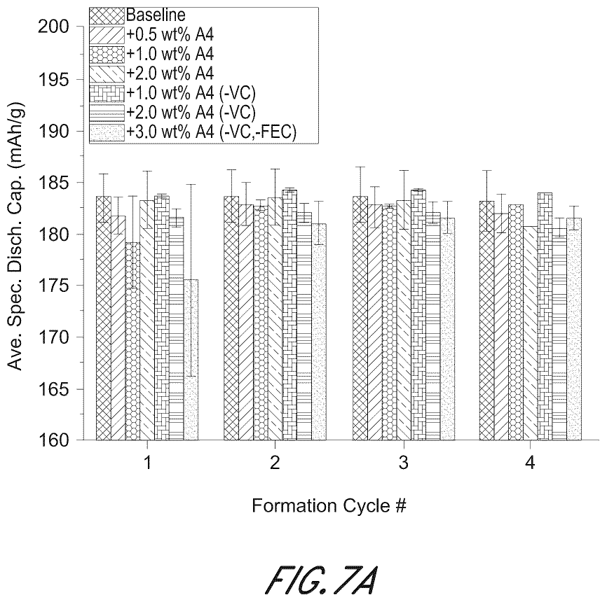

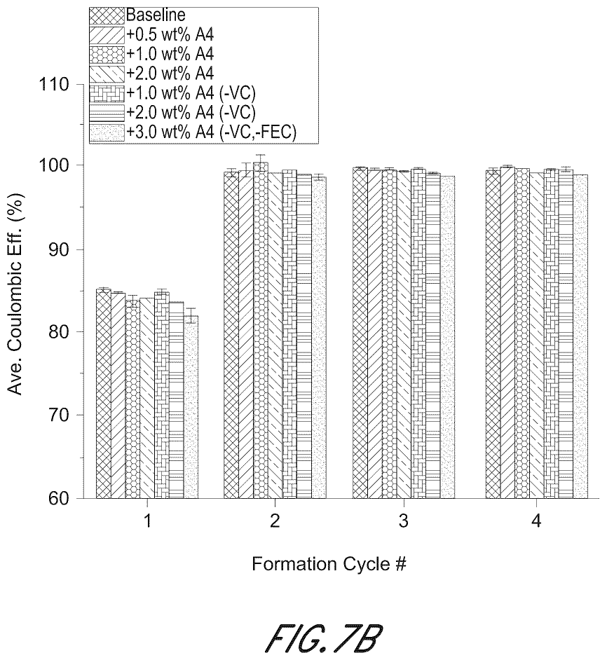

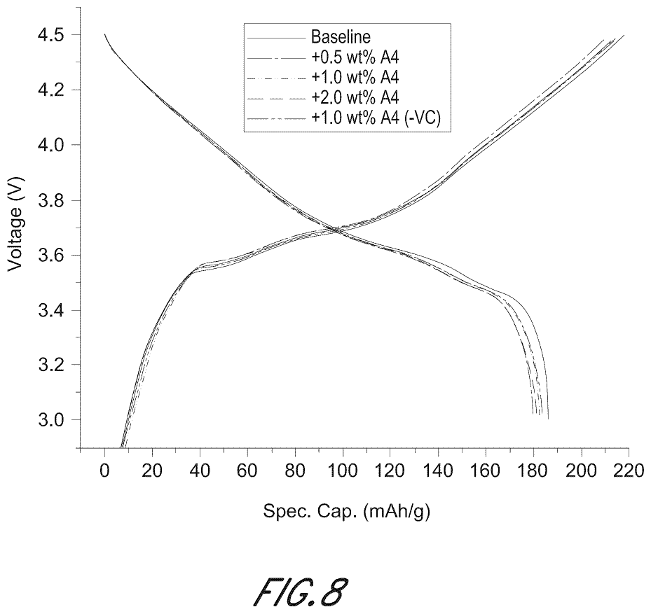

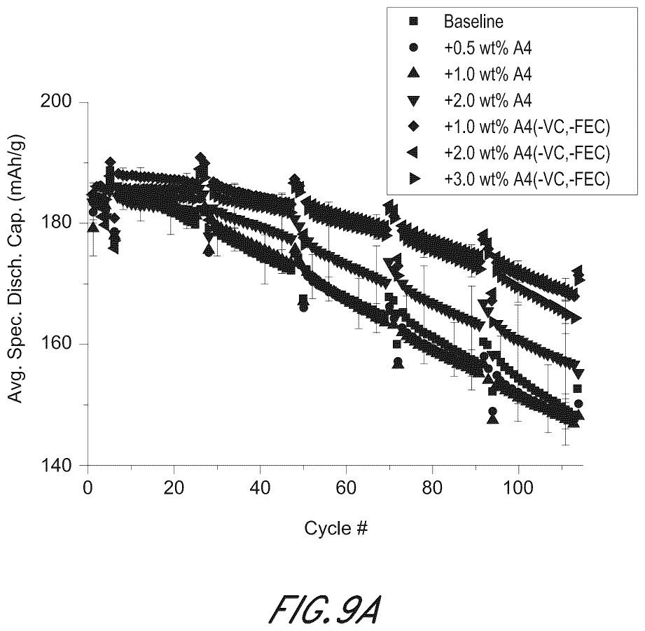

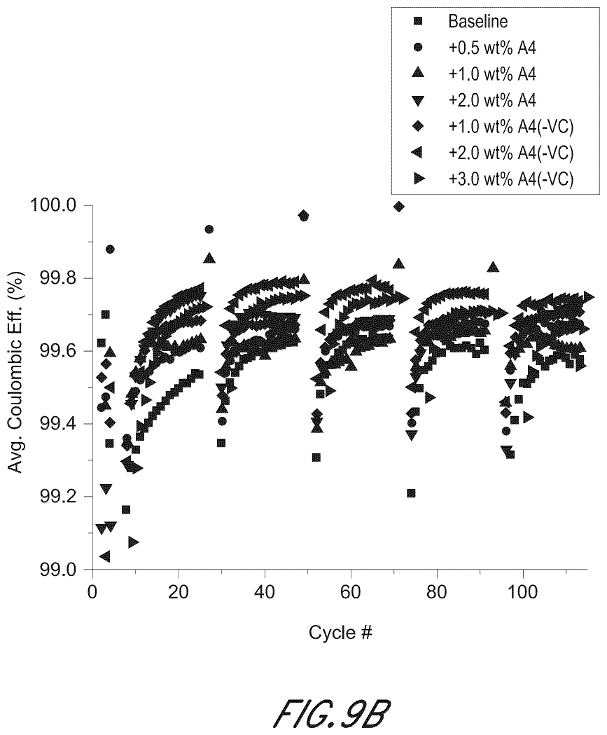

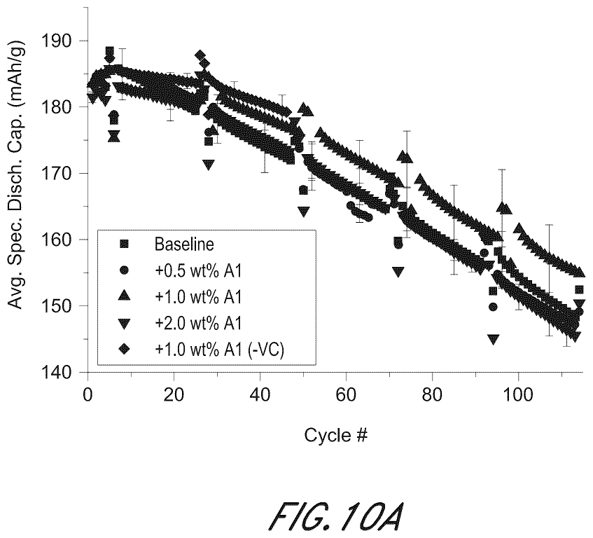

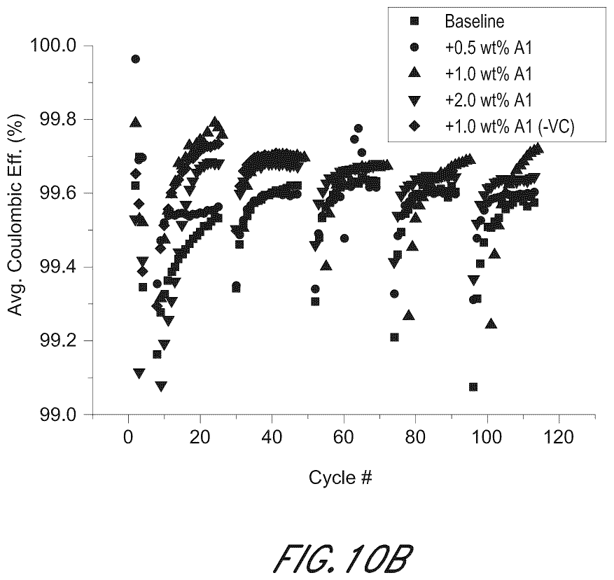

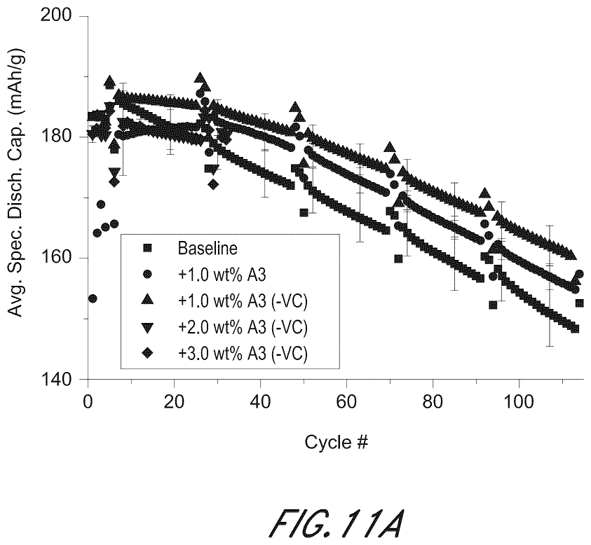

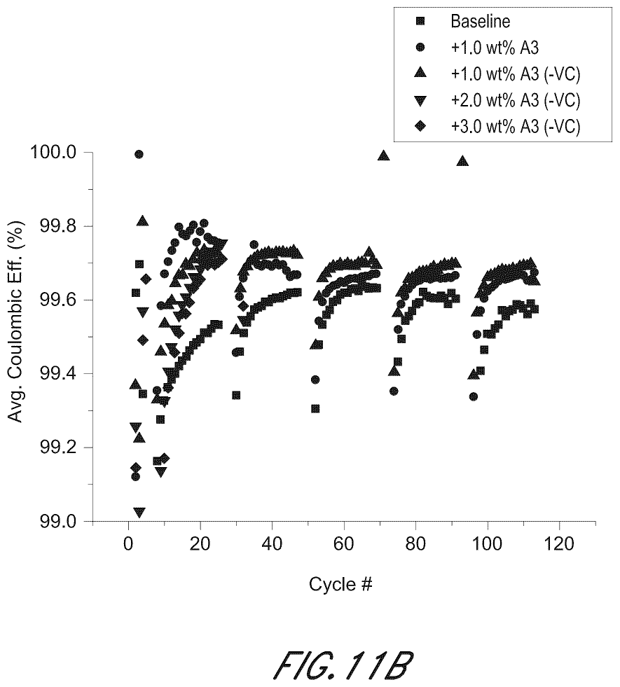

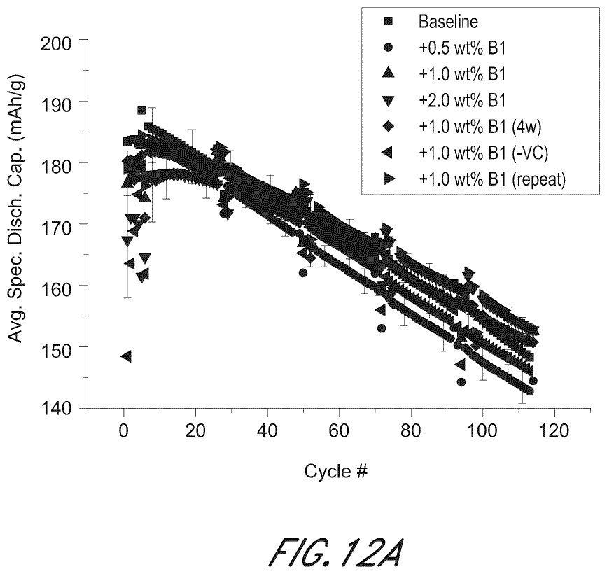

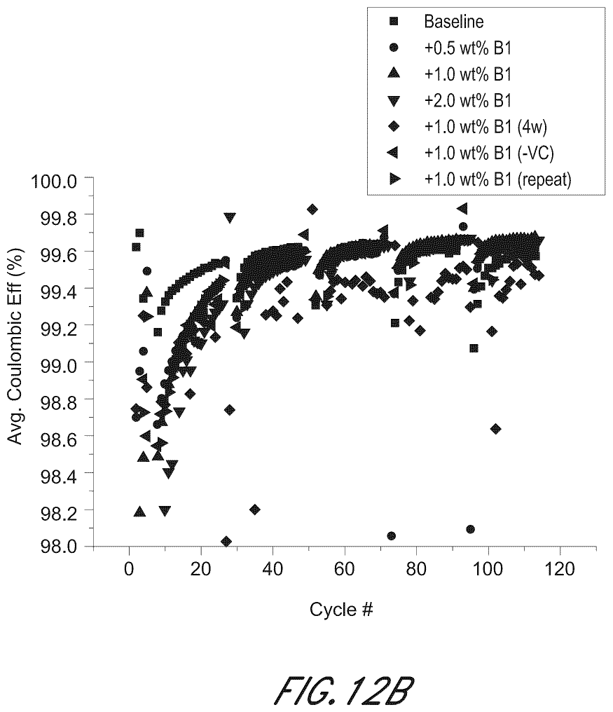

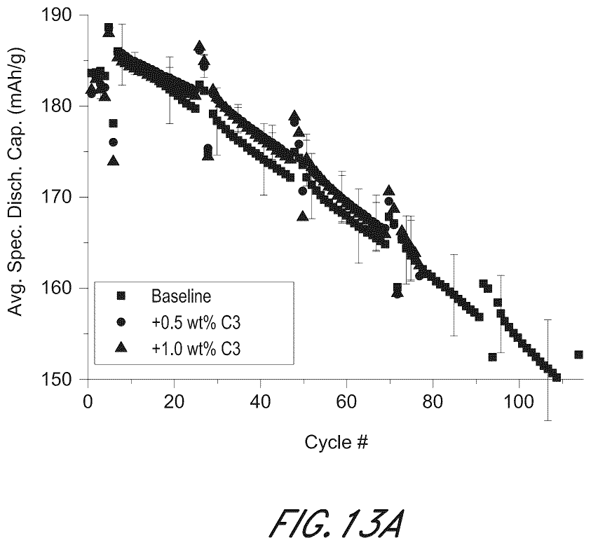

Discharge performance and cycling performance under aggressive or stressed conditions were tested for several lithium-ion batteries. FIG. 1A illustrates the number of cycles to reach a capacity of 160 mAh/g for lithium-ion batteries with an electrolyte system comprising a compound according to some embodiments, relative to a baseline electrolyte system. In addition, FIG. 1B illustrates the number of cycles to reach 90% of the initial capacity for lithium-ion batteries with an electrolyte system comprising a compound according to some embodiments, relative to a baseline electrolyte system.

### Example 3—Passivation Impact of Additive c-D7

The passivation impact of the coin cells of Example 1 containing an electrolyte system comprising various amounts of additive c-D7 (also “S2-7”) were tested. For all the experiments carried out, the cis-isomer of additive D7 was used. Isomeric purity of the starting materials was effectively 100%, and isomerization was prevented while working with the additive. FIG. 2A is a line chart illustrating the passivation impact between 0.5 V to 4.5 V during the formation cycle of cells containing electrolyte systems including:
(a) 0.7 wt. % fluoroethylene carbonate (FEC) and 0.25 wt. % vinylene carbonate (VC) (“black line”; “baseline”);
(b) 0.5 wt. % additive c-D7; 0.7 wt. % FEC; and 0.25 wt. % VC (“blue line”; “0.5 wt % S2-7”)
(c) 1.0 wt. % additive c-D7; 0.7 wt. % FEC; and 0.25 wt. % VC (“red line”; “1.0 wt S2-7”)
(d) 2.0 wt. % additive c-D7; 0.7 wt. % FEC; and 0.25 wt. % VC (“purple line”; “2.0 wt % S2-7”);
(e) 1.0 wt. % additive c-D7 and 0.7 wt. % FEC (“pink line”; “1.0 wt % S2-7(−VC)”);
(f) 2.0 wt. % additive c-D7 and 0.7 wt. % FEC (“green line”; “2.0 wt % S2-7(−VC)”); and
(g) 1.0 wt. % additive c-D7 (“orange line”; “1.0 wt % S2-7(−VC,-FEC)”).

FIG. 2B is an expanded view of the line chart of FIG. 2A illustrating the passivation impact between 1.5 V to 3.5 V. As seen in FIG. 2B, the addition of FEC and/or VC to an electrolyte system comprising 1.0 wt. % additive c-D7 formed relatively similar amounts of Solid Electrolyte Interface (SEI) compared to an electrolyte system comprising 1.0 wt. % additive c-D7 without VC, in addition to an electrolyte system comprising 1.0 wt. % additive c-D7 without VC and FEC. As such, the addition of FEC and/or VC did not or did not substantially negatively affect the formation cycle of an electrolyte system comprising 1.0 wt. % additive c-D7 as seen by similar amounts of SEI was formed between 1.5 V and 2.75 V. The addition of additive c-D7 as low as 0.5 wt. % showed improved results compared to the baseline, as effective amounts of SEI was formed with the addition of additive c-D7 to the electrolyte systems. Surprisingly, electrolyte systems including 1.0 wt. % additive c-D7, with or without FEC and/or VC, formed sufficient amounts of SEI.

### Example 4—Average Discharge Capacity and Coulombic Efficiency Impact of Additive c-D7

The average discharge capacity and average coulombic efficiency as a function of cycle numbers for the coin cells of Example 1 containing an electrolyte system comprising various amounts of additive c-D7 (also “S2-7”) were tested. FIG. 3A illustrates the average specific discharge capacity versus cycle number of electrolyte systems including:
(a) 0.7 wt. % fluoroethylene carbonate (FEC) and 0.25 wt. % vinylene carbonate (VC) (“black bar”; “baseline”);
(b) 0.5 wt. % additive c-D7; 0.7 wt. % FEC; and 0.25 wt. % VC (“blue bar”; “0.5 wt. % S2-7”);
(c) wt. % additive c-D7; 0.7 wt. % FEC; and 0.25 wt. % VC (“red bar”; “1.0 wt % S2-7”);
(d) 2.0 wt. % additive c-D7; 0.7 wt. % FEC; and 0.25 wt. % VC (“purple bar”; “2.0 wt % S2-7”);
(e) wt. % additive c-D7 and 0.7 wt. % FEC (“green bar”; “1.0 wt. % S2-7(−VC)”);
(f) 2.0 wt. % additive c-D7 and 0.7 wt. % FEC (“brown bar”; “2.0 wt % S2-7(−VC)”); and (g) wt. % additive c-D7 (“pink bar”; “1.0 wt % S2-7(−VC,−FEC)”).

FIG. 3B shows the average coulombic efficiency versus cycle number of cells utilizing the same electrolyte formulations as FIG. 3A. As seen in FIGS. 3A and 3B, the addition of FEC and/or VC to an electrolyte system comprising 1.0 wt. % additive c-D7 provided relatively similar average specific discharge capacity and average coulombic efficiency compared to an electrolyte system comprising 1.0 wt. % additive c-D7 without VC, in addition to an electrolyte system comprising 1.0 wt. % additive c-D7 without VC and FEC. As such, the addition of FEC and/or VC did not or did not substantially negatively affect the average specific discharge capacity or average coulombic efficiency of an electrolyte system comprising 1.0 wt. % additive c-D7 after four formation cycles. In addition, after four cycles, electrolyte systems including 1.0 wt. % additive c-D7, FEC, and VC provided superior discharge capacity compared to the baseline electrolyte systems, which did not include additive c-D7.

### Example 5—Electrochemical Performance impact of Additive c-D7

The electrochemical performance for the coin cells of Example 1 containing an electrolyte system comprising various amounts of additive c-D7 (also “S2-7”) was tested. FIG. 4 illustrates the voltage versus specific discharge capacity of electrolyte systems including:
(a) 0.7 wt. % fluoroethylene carbonate (FEC) and 0.25 wt. % vinylene carbonate (VC) (“black line”; “baseline”);
(b) 0.5 wt. % additive c-D7; 0.7 wt. % FEC; and 0.25 wt. % VC (“blue line”; “0.5 wt % S2-7”);
(c) wt. % additive c-D7; 0.7 wt. % FEC; and 0.25 wt. % VC (“red line” “1.0 wt % S2-7”);
(d) 2.0 wt. % additive c-D7; 0.7 wt. % FEC; and 0.25 wt. % VC (“purple line”; “2.0 wt % S2-7”);
(e) wt. % additive c-D7 and 0.7 wt. % FEC (“pink line”; “1.0 wt % S2-7(−VC)”);
(f) 2.0 wt. % additive c-D7 and 0.7 wt. % FEC (“green line”; “2.0 wt % S2-7(−VC)”); and
(g) wt. % additive c-D7 (“orange line”; “1.0 wt % S2-7(−VC,−FEC)”).

As seen in FIG. 4, the addition of FEC and VC to an electrolyte system comprising 1.0 wt. % additive c-D7 provided relatively similar electrochemical performance compared to an electrolyte system comprising 1.0 wt. % additive c-D7 without FEC and VC. As such, the addition of FEC and VC did not or did not substantially negatively affect the specific capacity of an electrolyte system comprising 1.0 wt. % additive c-D7.

### Example 6—Cycling Performance Impact of Additive c-D7

The cycling performance for the coin cells of Example 1 containing an electrolyte system comprising various amounts of additive c-D7 (also “S2-7”) was tested. FIG. 5A illustrates the average specific discharge capacity of NMC532 cells cycled between 3.0 V and 4.4 V at 40° C., with electrolyte systems including:
(a) 0.7 wt. % fluoroethylene carbonate (FEC) and 0.25 wt. % vinylene carbonate (VC) (“black square”; “baseline”);
(b) 0.5 wt. % additive c-D7; 0.7 wt. % FEC; and 0.25 wt. % VC (“blue circle”; “0.5 wt % S2-7”);
(c) wt. % additive c-D7; 0.7 wt. % FEC; and 0.25 wt. % VC (“red triangle”; “1.0 wt. % S2-7”)
(d) 2.0 wt. % additive c-D7; 0.7 wt. % FEC; and 0.25 wt. % VC (“purple triangle”; “2.0 wt % S2-7”);
(e) wt. % additive c-D7 and 0.7 wt. % FEC (“green square”; “1.0 wt % S2-7(−VC)”);
(f) 2.0 wt. % additive c-D7 and 0.7 wt. % FEC (“brown triangle”; “2.0 wt % S2-7(−VC)”); and
(g) wt. % additive c-D7 (“pink triangle”; “1.0 wt % S2-7(−VC,−FEC)”).

FIG. 5B shows the average coulombic efficiency versus cycle number of cells utilizing the same electrolyte formulations as FIG. 5A. As seen in FIGS. 5A and 5B, the addition of additive c-D7 as low as 0.5 wt. % provided substantially superior average specific discharge capacity and average coulombic efficiency compared to the baseline electrolyte system, which did not include additive c-D7. Surprisingly, electrolyte systems including additive c-D7 and FEC, but without VC, also provided superior average specific discharge capacity and average coulombic efficiency compared to the baseline electrolyte system. More so, electrolyte systems including additive c-D7, but without FEC and VC, provided the best average specific discharge capacity and average coulombic efficiency compared to all the other tested electrolyte systems that included additive c-D7, in addition to the baseline electrolyte system.

### Example 7—Passivation Impact of Additive A4

The passivation impact of the coin cells of Example 1 containing an electrolyte system comprising various amounts of additive A4 (also “S3-2”) were tested. FIG. 6A is a line chart illustrating the passivation impact between 0.5 V to 4.5 V during the formation cycle of cells containing electrolyte systems including:
(a) 0.7 wt. % fluoroethylene carbonate (FEC) and 0.25 wt. % vinylene carbonate (VC) (“black line”; “baseline”);
(b) 0.5 wt. % additive A4; 0.7 wt. % FEC; and 0.25 wt. % VC (“blue line”; “0.5 wt % S3-2”);
(c) wt. % additive A4; 0.7 wt. % FEC; and 0.25 wt. % VC (“red line”; “1.0 wt % S3-2”);
(d) 2.0 wt. % additive A4; 0.7 wt. % FEC; and 0.25 wt. % VC (“purple line”; “2.0 wt % S3-2”);
(e) wt. % additive A4 and 0.7 wt. % FEC (“orange line”; “1.0 wt % S3-2(−VC)”);
(f) 2.0 wt. % additive A4 and 0.7 wt. % FEC (“brown line” “2.0 wt % S3-2(−VC)”); and
(g) 3.0 wt. % additive A4 and 0.7 wt. % FEC (“pink line”; “3.0 wt % S3-2(−VC)”).

FIG. 6B is an expanded view of the line chart of FIG. 6A illustrating the passivation impact between 1.5 V to 3.5 V. As seen in FIG. 6B, the addition of VC to an electrolyte system comprising 1.0 wt. % additive A4 formed relatively similar amounts of Solid Electrolyte Interface (SEI) compared to an electrolyte system comprising 1.0 wt. % additive A4 without VC. As such, the addition of VC did not or did not substantially negatively affect the formation cycle of an electrolyte system comprising 1.0 wt. % additive A4 because relatively similar amounts of SEI was formed between 1.5 V and 2.75 V.

### Example 8—Average Discharge Capacity and Coulombic Efficiency Impact of Additive A4

The average discharge capacity and average coulombic efficiency as a function of cycle numbers for the coin cells of Example 1 containing an electrolyte system comprising various amounts of additive A4 (also “S3-2”) were tested. FIG. 7A illustrates the average specific discharge capacity versus cycle number of electrolyte systems including:
(a) 0.7 wt. % fluoroethylene carbonate (FEC) and 0.25 wt. % vinylene carbonate (VC) (“black bar”; “baseline”);
(b) 0.5 wt. % additive A4; 0.7 wt. % FEC; and 0.25 wt. % VC (“blue bar”; “0.5 wt % S3-2”);
(c) wt. % additive A4; 0.7 wt. % FEC; and 0.25 wt. % VC (“red bar”; “1.0 wt. % S3-2”);
(d) 2.0 wt. % additive A4; 0.7 wt. % FEC; and 0.25 wt. % VC (“purple bar”; “2.0 wt. % S3-2”);
(e) wt. % additive A4 and 0.7 wt. % FEC (“orange bar”; “1.0 wt % 3-2(−VC)”);
(f) 2.0 wt. % additive A4 and 0.7 wt. % FEC (“brown bar”; “2.0 wt % S3-2(−VC)”); and
(g) 3.0 wt. % additive A4 and 0.7 wt. % FEC (“pink bar”; “3.0 wt % S3-2(−VC)”).

FIG. 7B shows the average coulombic efficiency versus cycle number of cells utilizing the same electrolyte formulations as FIG. 7A. As seen in FIGS. 7A and 7B, the addition of VC to an electrolyte system comprising 1.0 wt. % additive A4 provided relatively similar average specific discharge capacity and average coulombic efficiency compared to an electrolyte system comprising 1.0 wt. % additive A4 without VC. As such, the addition of VC did not or did not substantially negatively affect the average specific discharge capacity or average coulombic efficiency of an electrolyte system comprising 1.0 wt. % additive A4 after four formation cycles.

### Example 9—Electrochemical Performance Impact of Additive A4

The electrochemical performance for the coin cells of Example 1 containing an electrolyte system comprising various amounts of additive A4 (also “S3-2”) was tested. FIG. 8 illustrates the voltage versus specific discharge capacity of electrolyte systems including:
(a) 0.7 wt. % fluoroethylene carbonate (FEC) and 0.25 wt. % vinylene carbonate (VC) (“black line”; “baseline”);
(b) 0.5 wt. % additive A4; 0.7 wt. % FEC; and 0.25 wt. % VC (“blue line”; “0.5 wt. % S3-2”);
(c) wt. % additive A4; 0.7 wt. % FEC; and 0.25 wt. % VC (“red line”; “1.0 wt. % S3-2”);
(d) 2.0 wt. % additive A4; 0.7 wt. % FEC; and 0.25 wt. % VC (“purple line”; “2.0 wt. % S3-2”); and
(e) wt. % additive A4 and 0.7 wt. % FEC (“orange line”; “1.0 wt % S3-2(−VC)”).

As seen in FIG. 8, the addition of VC to an electrolyte system comprising 1.0 wt. % additive A4 provided relatively similar electrochemical performance compared to an electrolyte system comprising 1.0 wt. % additive A4 without VC. As such, the addition of VC did not or did not substantially negatively affect the specific capacity of an electrolyte system comprising 1.0 wt. % additive A4.

### Example 10—Cyclin& Performance Impact of Additive A4

The cycling performance for the coin cells of Example 1 containing an electrolyte system comprising various amounts of additive A4 (also “S3-2”) was tested. FIG. 9A illustrates the average specific discharge capacity of NMC532 cells cycled between 3.0 V and 4.4 V at 40° C., with electrolyte systems including:
(a) 0.7 wt. % fluoroethylene carbonate (FEC) and 0.25 wt. % vinylene carbonate (VC) (“black square”; “baseline”);
(b) 0.5 wt. % additive A4; 0.7 wt. % FEC; and 0.25 wt. % VC (“blue circle”; “0.5 wt % S3-2”);
(c) wt. % additive A4; 0.7 wt. % FEC; and 0.25 wt. % VC (“red triangle”; “1.0 wt % S3-2”);
(d) 2.0 wt. % additive A4; 0.7 wt. % FEC; and 0.25 wt. % VC (“purple triangle”; “2.0 wt % S3-2”);
(e) wt. % additive A4 (“orange square”; “1.0 wt % S3-2(−VC,−FEC)”);
(f) 2.0 wt. % additive A4 (“brown triangle”; “2.0 wt. % S3-2(−VC,−FEC)”); and
(g) 3.0 wt. % additive A4 (“pink triangle”; “3.0 wt % S3-2(−VC,−FEC)”).

FIG. 9B shows the average coulombic efficiency of NMC532 cells cycled between 3.0 V and 4.4 V at 40° C., with electrolyte systems including:
(a) 0.7 wt. % FEC and 0.25 wt. % VC (“black square”; “baseline”); (b) 0.5 wt. % additive A4; 0.7 wt. % FEC; and 0.25 wt. % VC (“blue circle”; “0.5 wt %/o S3-2”);
(c) wt. % additive A4; 0.7 wt. % FEC; and 0.25 wt. % VC (“red triangle”; “1.0 wt % S3-2”);
(d) 2.0 wt. % additive A4; 0.7 wt. % FEC; and 0.25 wt. % VC (“purple triangle”; “2.0 wt % S3-2”);
(e) wt. % additive A4 and 0.7 wt. % FEC (“orange square”; “1.0 wt. % S3-2(−VC)”);
(f) 2.0 wt. % additive A4 and 0.7 wt. % FEC (“brown triangle”; “2.0 wt % S3-2(−VC)”); and
(g) 3.0 wt. % additive A4 and 0.7 wt. % FEC (“pink triangle”; “3.0 wt % S3-2(−VC)”).

As seen in FIGS. 9A and 9B, the addition of additive A4 provided superior average specific discharge capacity and average coulombic efficiency compared to the baseline electrolyte systems, which did not include additive A4.

### Example 11—Cycling Performance Impact of Additive A1

The cycling performance for the coin cells of Example 1 containing an electrolyte system comprising various amounts of additive A1 (also “S4-1”) was tested. FIG. 10A illustrates the average specific discharge capacity of NMC532 cells cycled between 3.0 V and 4.4 V at 40° C., with electrolyte systems including:
(a) 0.7 wt. % fluoroethylene carbonate (FEC) and 0.25 wt. % vinylene carbonate (VC) (“black square”; “baseline”);
(b) 0.5 wt. % additive A1; 0.7 wt. % FEC; and 0.25 wt. % VC (“blue circle”; “0.5 wt % S4-1”);
(c) wt. % additive A1; 0.7 wt. % FEC; and 0.25 wt. % VC (“red triangle”; “1.0 wt % S4-1”);
(d) 2.0 wt. % additive A1; 0.7 wt. % FEC; and 0.25 wt. % VC (“purple triangle”; “2.0 wt % S4-1”); and
(e) wt. % additive A1 and 0.7 wt. % FEC (“orange square”; “1.0 wt % S4-1(−VC)”).

FIG. 10B shows the average coulombic efficiency versus cycle number of cells utilizing the same electrolyte formulations as FIG. 10A. As seen in FIGS. 10A and 10B, the addition of additive A1 provided superior average specific discharge capacity and average coulombic efficiency compared to the baseline electrolyte systems, which did not include additive A1.

### Example 12—Cycling Performance Impact of Additive A3

The cycling performance for the coin cells of Example 1 containing an electrolyte system comprising various amounts of additive A3 (also “S4-2”) was tested. FIG. 11A illustrates the average specific discharge capacity of NMC532 cells cycled between 3.0 V and 4.4 V at 40° C., with electrolyte systems including:
(a) 0.7 wt. % fluoroethylene carbonate (FEC) and 0.25 wt. % vinylene carbonate (VC) (“black square”; “baseline”);
(b) wt. % additive A3; 0.7 wt. % FEC; and 0.25 wt. % VC (“blue circle”; “0.5 wt % 54-2”); (c) wt. % additive A3 and 0.7 wt. % FEC (“red triangle”; “1.0 wt % S4-2(−VC)”);
(d) 2.0 wt. % additive A3 and 0.7 wt. % FEC (“purple triangle”; “2.0 wt % S4-2(−VC)”); and
(e) 3.0 wt. % additive A3 and 0.7 wt. % FEC (“orange square”; “3.0 wt % S4-2(−VC)”).

FIG. 11B shows the average coulombic efficiency versus cycle number of cells utilizing the same electrolyte formulations as FIG. 11A. As seen in FIGS. 11A and 11B, the addition of additive A3 provided superior average specific discharge capacity and average coulombic efficiency compared to the baseline electrolyte systems, which did not include additive A3.

### Example 13—Cycling Performance Impact of Additive B1

The cycling performance for the coin cells of Example 1 containing an electrolyte system comprising various amounts of additive B1 (also “SP-1”) was tested. FIG. 12A illustrates the average specific discharge capacity of NMC532 cells cycled between 3.0 V and 4.4 V at 40° C., with electrolyte systems including:
(a) 0.7 wt. % fluoroethylene carbonate (FEC) and 0.25 wt. % vinylene carbonate (VC) (“black square”; “baseline”);
(b) 0.5 wt. % additive B1; 0.7 wt. % FEC; and 0.25 wt. % VC (“blue circle”; “0.5 wt % SP-1”);
(c) wt. % additive B1; 0.7 wt. % FEC; and 0.25 wt. % VC (“red triangle”; “green triangle”; “1.0 wt % SP-1”; “repeat”);
(d) 2.0 wt. % additive B1; 0.7 wt. % FEC; and 0.25 wt. % VC (“purple triangle”; “2.0 wt % SP-1”); and
(e) wt. % additive B1 aged for 4 weeks; 0.7 wt. % FEC; and 0.25 wt. % VC (“orange square”; “1.0 wt % SP-1 (4w)”); and
(f) wt. % additive B1 and 0.7 wt. % FEC (“brown triangle”; “1.0 wt % SP-1 (−VC)”).

FIG. 12B shows the average coulombic efficiency versus cycle number of cells utilizing the same electrolyte formulations as FIG. 12A. As seen in FIGS. 12A and 12B, the addition of more than 0.5 wt. % additive B1 provided superior average specific discharge capacity and average coulombic efficiency compared to the baseline electrolyte systems, which did not include additive B1.

### Example 14—Cycling Performance Impact of Additive C3

The cycling performance for the coin cells of Example 1 containing an electrolyte system comprising various amounts of additive C3 (also “DA-1”) was tested. FIG. 13A illustrates the average specific discharge capacity of NMC532 cells cycled between 3.0 V and 4.4 V at 40° C., with electrolyte systems including;
(a) 0.7 wt. % fluoroethylene carbonate (FEC) and 0.25 wt. % vinylene carbonate (VC) (“black square”; “baseline”);
(b) 0.5 wt. % additive C3; 0.7 wt. % FEC; and 0.25 wt. % VC (“blue circle”; “0.5 wt % DA-1”); and
(c) wt. % additive C3; 0.7 wt. % FEC; and 0.25 wt. % VC (“red triangle”; “1.0 wt % DA-1”).

FIG. 13B shows the average coulombic efficiency versus cycle number of cells utilizing the same electrolyte formulations as FIG. 13A. As seen in FIGS. 13A and 13B, the addition of additive C3 provided superior or relatively similar average specific discharge capacity and average coulombic efficiency for over 70 cycles compared to the baseline electrolyte systems, which did not include additive C3.

### Example 15—Cycling Performance Impact of Additives D2, D4, and D6

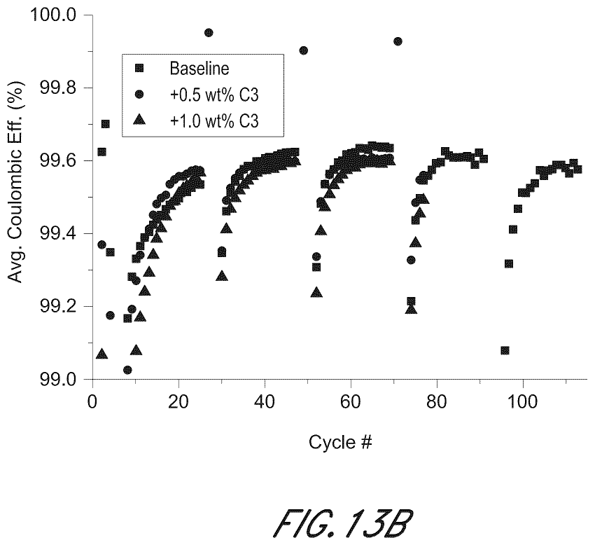

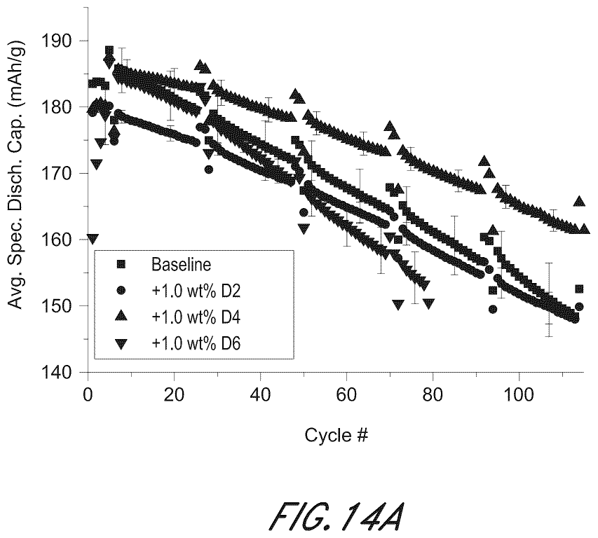

The cycling performance for the coin cells of Example 1 containing an electrolyte system comprising a compound according to some embodiments were tested. FIG. 14A illustrates the average specific discharge capacity of NMC532 cells cycled between 3.0 V and 4.4 V at 40° C., with electrolyte systems including:
(a) 0.7 wt. % fluoroethylene carbonate (FEC) and 0.25 wt. % vinylene carbonate (VC) (“black square”; “baseline”);
(b) wt. % additive D2 (also “S2-1”); 0.7 wt. % FEC; and 0.25 wt. % VC (“blue circle”; “1.0 wt % S2-1”);
(c) wt. % additive D4 (also “S2-3”); 0.7 wt. % FEC; and 0.25 wt. % VC (“red triangle”; “1.0 wt % S2-3”); and
(d) wt. % additive D6 (also “S2-5”); 0.7 wt. % FEC; and 0.25 wt. % VC (“green triangle”; “1.0 wt % S2-5”).

FIG. 14B shows the average coulombic efficiency versus cycle number of cells utilizing the same electrolyte formulations as FIG. 14A. As seen in FIG. 14A, the addition of additive D4 provided superior average specific discharge capacity compared to the baseline electrolyte system, which did not include additive D4. In addition, as seen in FIGS. 14B, the addition of additive D2 or D4 provided superior average coulombic efficiency compared to the baseline electrolyte systems, which did not include additive D2 or D4.

### Example 16—Cycling Performance Impact of Additive G1

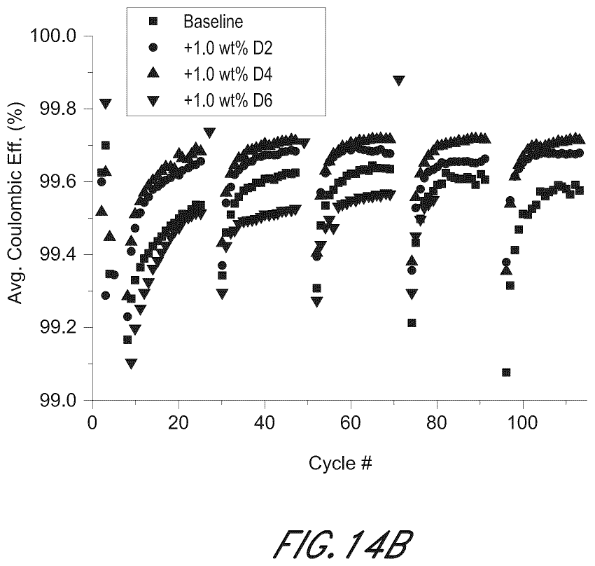

The cycling performance for the coin cells of Example 1 containing an electrolyte system comprising various amounts of additive G1 (also “N1-8”) was tested. FIG. 15 illustrates the discharge capacity of NMC532 cells cycled between 3.0 V and 4.4 V at 40° C., with electrolyte systems including:
(a) 0.7 wt. % fluoroethylene carbonate (FEC) and 0.25 wt. % vinylene carbonate (VC) (“black square”; “baseline”);
(b) 0.2 wt. % additive G1; 0.7 wt. % FEC; and 0.25 wt. % VC (“blue circle”; “0.2 wt. % N1-8”);
(c) 0.5 wt. % additive G1; 0.7 wt. % FEC; and 0.25 wt. % VC (“red triangle”; “0.5 wt % N1-8”);
(d) wt. % additive G1; 0.7 wt. % FEC; and 0.25 wt. % VC (“green triangle”; “1.0 wt % N1-8”); and
(e) 2.0 wt. % additive G1; 0.7 wt. % FEC; and 0.25 wt. % VC (“orange square”; “2.0 wt. % N1-8”).

As seen in FIGS. 15, the addition of less than 2 wt. % of additive G1 provided superior discharge capacity compared to the baseline electrolyte systems, which did not include additive G1.

### Example 17—Aging

The electrolyte additives were aged for a period of time to allow for the conversion of the additive to a final product form, through reaction with 1.5 M LiPF₆ salt. The conversion times were determined by NMR measurements. Table 2 summarizes the electrolyte additives that were aged, their final LiPF₆ salt forms, and the conversion times.

TABLE 2
Summary of Aging Conversion

| | | | Time to | |
|---|---|---|---|---|
| | | Structure After Conversion | 100% | |
| Name | Structure | (“Final Salt Form”) | Conversion | |
| A1 (also “S4-1”) | 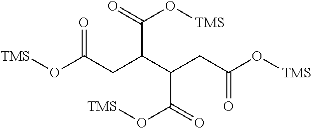 [SMILES: C[Si](C)(C)OC(=O)CC(C(=O)O[Si](C)(C)C)C(CC(=O)O[Si](C)(C)C)C(=O)O[Si](C)(C)C] | 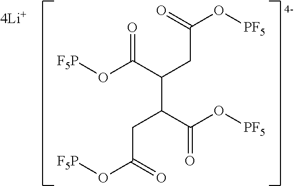 | <3 | weeks |
| A3 (also “S4-2”) | 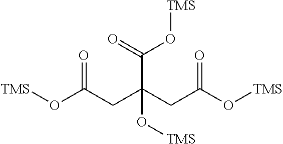 [SMILES: C[Si](C)(C)OC(=O)CC(CC(=O)O[Si](C)(C)C)(O[Si](C)(C)C)C(=O)O[Si](C)(C)C] | 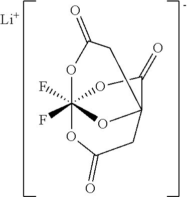 | >3 | weeks |
| B1 (also “SP-1”) | 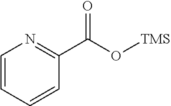 [SMILES: C[Si](C)(C)OC(=O)c1ccccn1] | 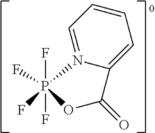 | <48 | hours |
| C3 (also “DA-1”) | 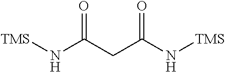 [SMILES: C[Si](C)(C)NC(=O)CC(=O)N[Si](C)(C)C] | 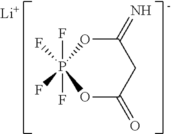 | <3 | weeks |
| c-D7 (also “S2-7”) | 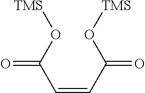 [SMILES: C[Si](C)(C)OC(=O)/C=C\C(=O)O[Si](C)(C)C] | 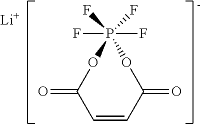 | <1 | week |
| D4 (also “S2-3” or bis(trimethylsilyl) malonate or “bTMSM”) | 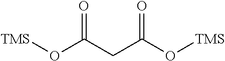 [SMILES: C[Si](C)(C)OC(=O)CC(=O)O[Si](C)(C)C] | 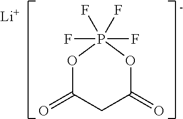 | <1 | week |

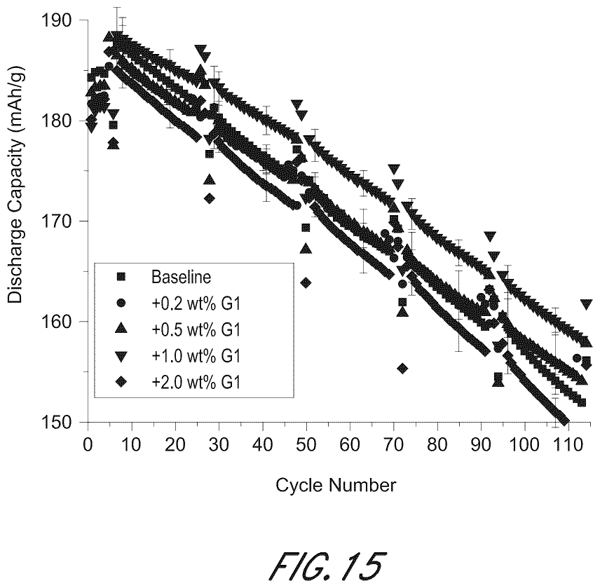

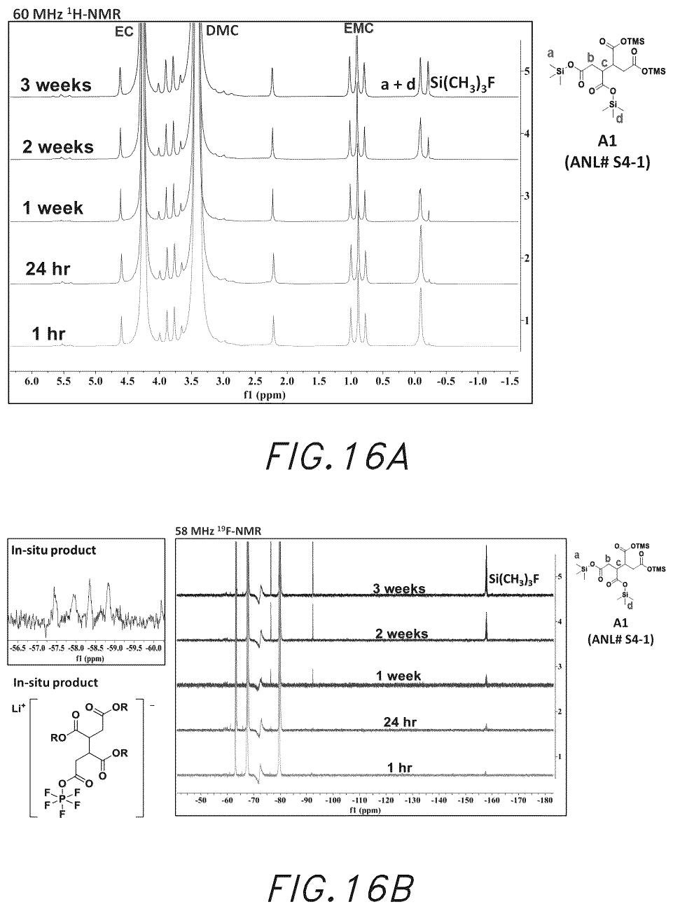

The conversion of the additives to the final products was monitored by ¹H and ¹⁹F NMR. FIG. 16A provides the conversion of additive A1 (also “S4-1”) to the final salt form product in electrolyte as a function of time by ¹H NMR. FIG. 16B provides the conversion of additive A1 (also “S4-1”) to the final salt form product in electrolyte as a function of time by ¹⁹F NMR. As shown in FIGS. 16A and 16B, as the in-situ product is formed, the byproduct of trimethylfluorosilane is also formed. The reaction is complete in less than three weeks.

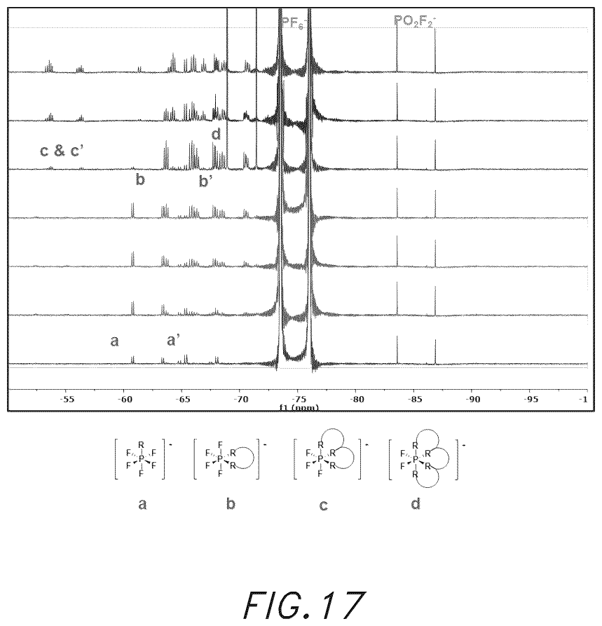

FIG. 17 shows ¹⁹F NMR spectra of the conversion of additive A3 (also “S4-2”) to the final product in an electrolyte as a function of time. Scheme 1 provides the proposed mechanism of the conversion of additive A3 (also “S4-2”) to the final product. Initial observation of the final product of A3 (also “S4-2”) was observed at 1 week in the electrolyte. After 2 weeks, a small amount of the parent compound was present via ¹H NMR. Based on ¹⁹F NMR, intermediary species were present at 3 weeks, although complete consumption of the parent compound was observed.

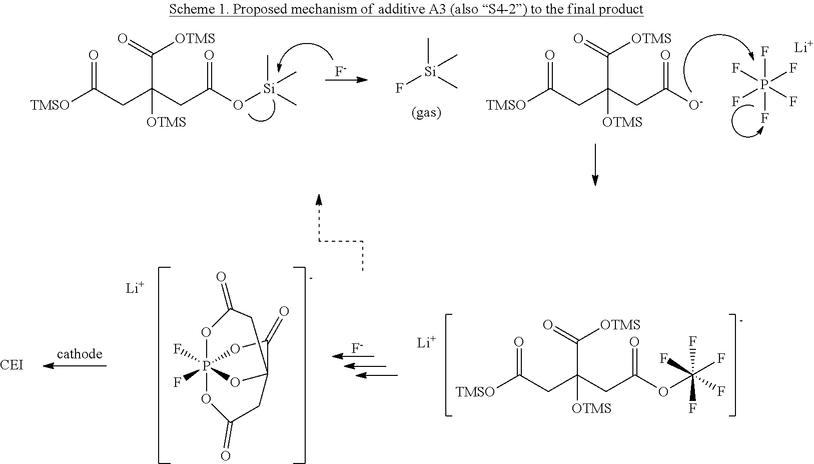

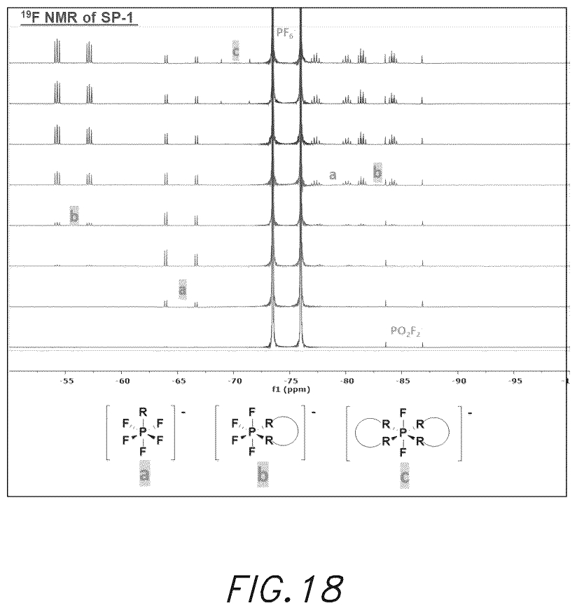

FIG. 18 shows ¹⁹F NMR spectra of the conversion of additive B1 (also “SP-1”) to the final product in an electrolyte as a function of time. Scheme 2 provides the proposed mechanism of the conversion of additive B1 (also “SP-1”) to the final product.

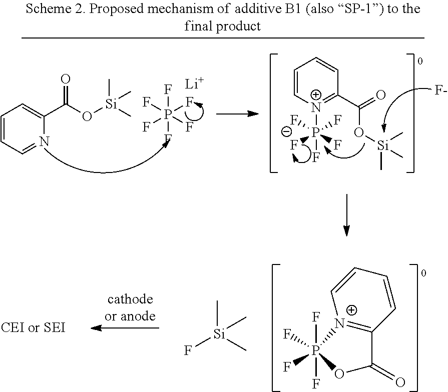

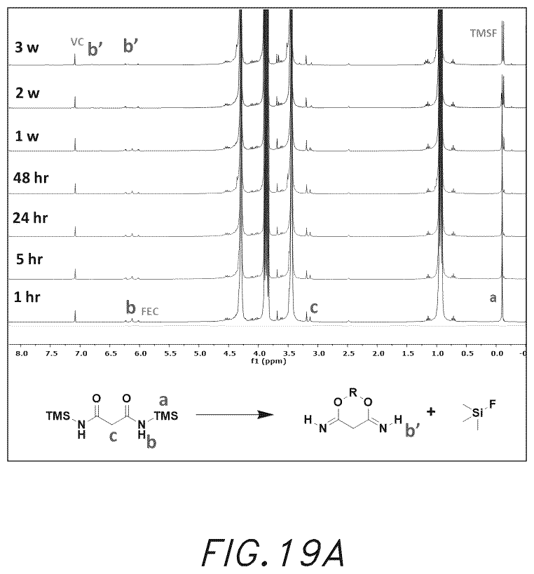

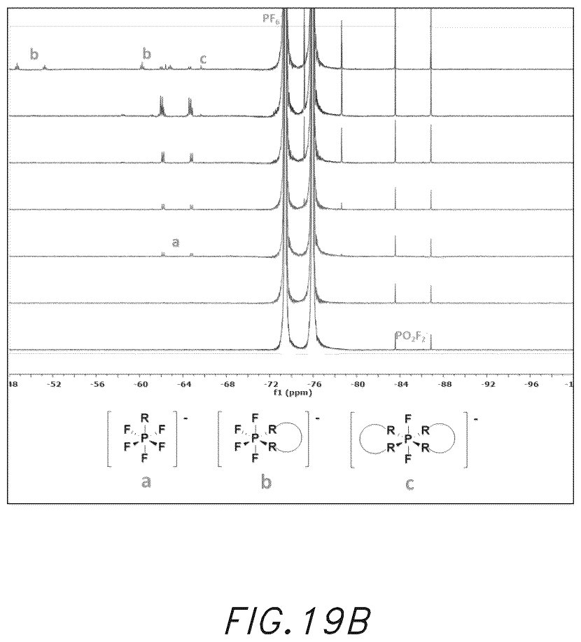

FIG. 19A shows ¹H NMR spectra of the conversion of additive C3 (also “DA-1”) to the final product in an electrolyte as a function of time. FIG. 19B provides the conversion of additive C3 (also “DA-1”) to the final salt form product in electrolyte as a function of time by ¹⁹F NMR. Scheme 3 provides the proposed mechanism of the conversion of additive C3 (also “DA-1”) to the final product.

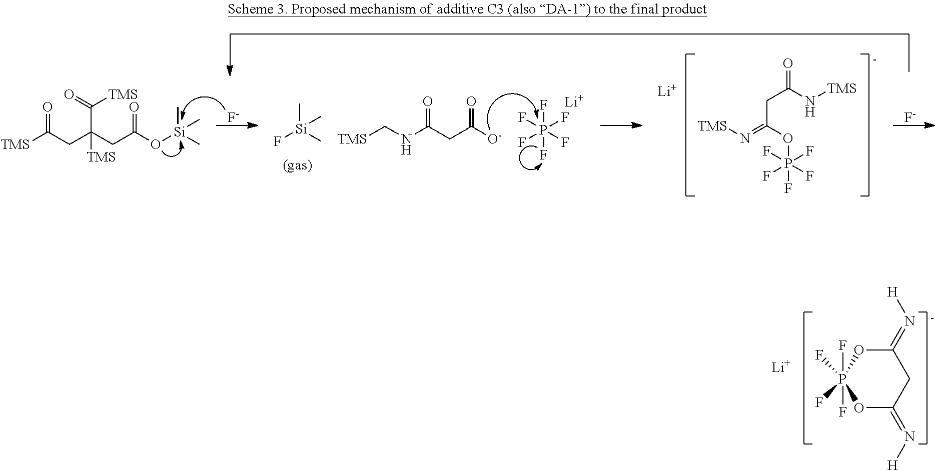

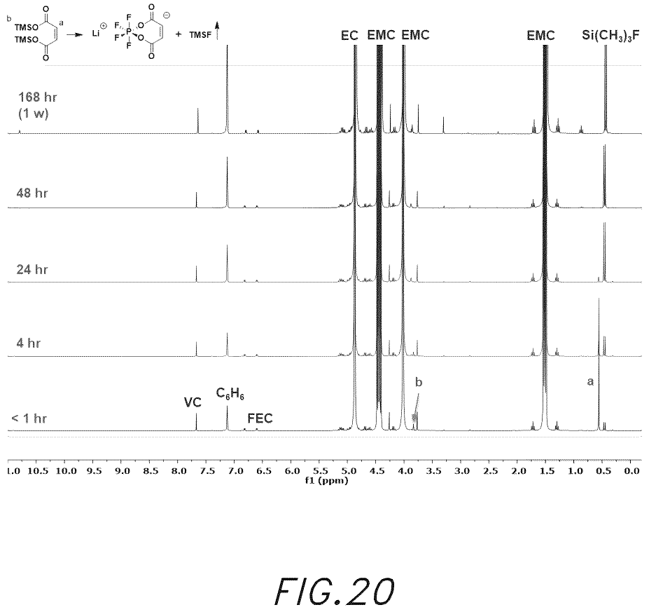

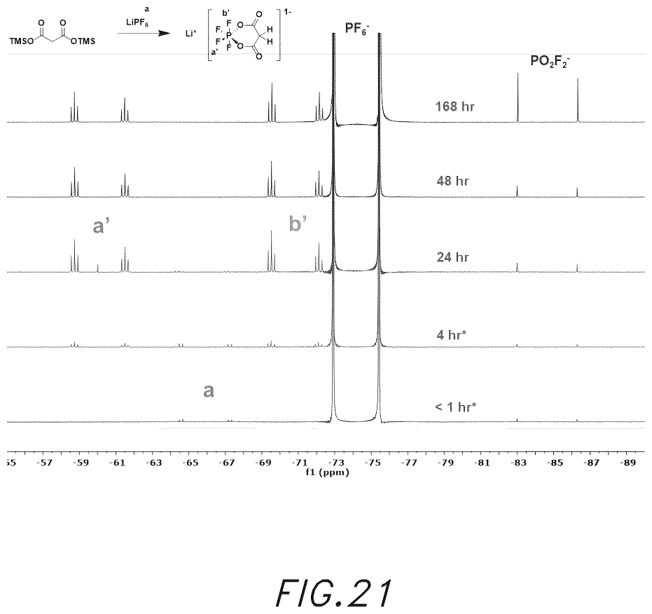

FIG. 20 shows ¹H NMR spectra of the conversion of additive c-D7 (also “S2-7”) to the final product in an electrolyte as a function of time. FIG. 21 shows ¹⁹F NMR spectra of the conversion of additive D4 (also “S2-3”) to the final product in an electrolyte as a function of time. As shown in FIG. 21, as the in-situ product is formed, the PO₂F₂⁻ and carbon suboxide (C₃O₂) byproducts are also formed. Without being bound by theory, it is believed that Formula (E) is produced through the polymerization of carbon suboxide.

### Example 18—Pouch Cell Specifications

Electrolyte additives were tested for their efficacy in NMC442/graphite pouch cells. Pouch cells were manufactured and vacuum sealed in a dry room without electrolyte. Table 3 summarizes the specifications of the pouch cells.

TABLE 3
NMC442/graphite Pouch Cell Specifications

| | |
|---|---|
| Positive Electrode | Negative Electrode |

| | | |
|---|---|---|
| Material | Li[Ni_{0 42}Mn_{0.42}CO_{0.16}]O₂ | Artificial Graphite |
| Active Area (cm²) | 86 | 99 |
| Electrode thickness (μm) | 31 | 66 |
| Loading (mg/cm²) | 10.5 | 10 |
| Active material percentage | 96 | 95 |

| | | | |
|---|---|---|---|
| Max. Charge Voltage | 4.7 | V | — |

| | | |
|---|---|---|
| Typical Charge Voltage | 4.4 V or 4.5 V | — |

| | | | |
|---|---|---|---|
| Capacity to 4.5 V at C/3 | 180 | mAh | — |

1 M or 1.5 M LiPF₆ in 25:5:70 weight ratio EC:EMC:DMC was used as the control electrolyte (“Comparative Electrolyte 1”). Electrolytes according to Comparative Electrolyte 1, but with 2 wt. % fluoroethylene carbonate (FEC) added (“Comparative Electrolyte 2”) or with 1 wt. % 1,3,6-hexanetricarbonitrile (HTCN or additive H₂ or also “N3-2”) added (“Comparative Electrolyte 3”) were also prepared. Electrolytes according to Comparative Electrolyte 1, but with various amounts of additives disclosed herein were also prepared, and described in the Examples below.

The prepared electrolytes were mixed in an argon-filled glove box. After filling with electrolytes, cells underwent a 24-hour wetting period where they were held at 1.5 V. Then the cells underwent formation at C/20 (12 mA) to either 4.4 V or 4.5 V depending on which upper cutoff potential the cells would ultimately be tested at. After charging to the upper cutoff, they were discharged to 3.0 V and charged to 3.8 V where impedance spectra were measured. In addition, cells were weighed under water and the weights recorded. Tested cells were also weighed under water so that gas volumes generated could be determined using Archimedes' principle.

### Example 19—Performances of Aged Electrolyte Pouch Cells

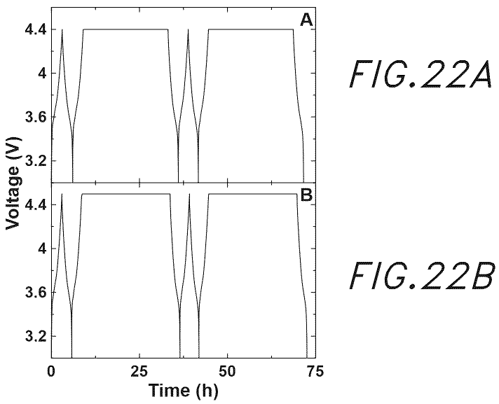

Pouch Cells were tested using comparative electrolytes and electrolyte formulations with additives described herein. Cells were charged and discharged at C/3 to either 4.4 V or 4.5, using the protocols shown in FIGS. 22A or 22B. After 2 cycles, cells were held at top of charge for 24 hours to allow long exposure to high voltage conditions. The actual currents used for the C/3 cycling were 53 mA for the 4.4 V tests and 60 mA for the 4.5 V tests. All testing was carried out at 40° C. Cells were tested until their capacities dropped below 100 mAh, at which point tests were terminated.

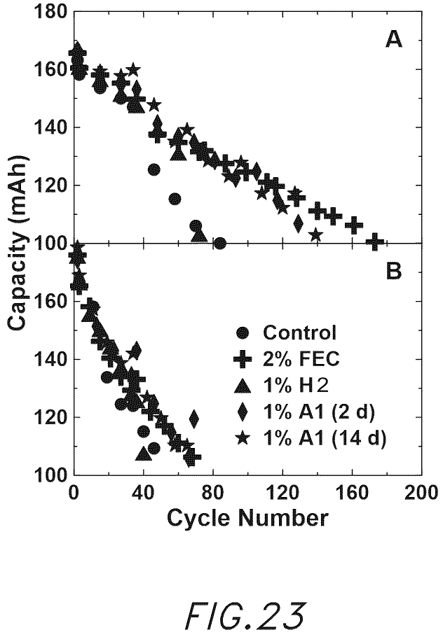

Test results are shown in FIG. 23, plotting cell capacity versus the number of charge-discharge cycles for Comparative Electrolyte 1 (“Control”), Comparative Electrolyte 2 (“2% FEC”), Comparative Electrolyte 3 (1 wt. % of additive H2 or “1% HTCN”), 1 wt. % of additive A1 aged for 2 days, and 1 wt. % of additive A1 aged for 14 days. FIG. 23 shows that additive A1 dramatically improves cell lifetime under these aggressive high voltage, high temperature conditions. Critically, cells with additive A1 outperformed cells with control electrolytes, such as Comparative Electrolyte 1 and Comparative Electrolyte 3 at both 4.4 V and 4.5 V.

The cells were also tested to evaluate their cycling performances when additives A1 and A3 are utilized. The number of cycles to reach 100 mA (i.e. 63% initial capacity retention) in FIG. 23 was used as a measurement of additive efficacy. The results of the number of cycles to 100 mAh for cells tested to an upper cutoff of 4.4 V are summarized in Table 3A. The results of the number of cycles to 100 mAh for cells tested to an upper cutoff of 4.5 V are summarized in Table 3B. The results reported are the average of data from two cells tested.

TABLE 3A
Summary of Number of Cycles Above 100 mAh at 4.4 V

| | | Number of Cycles |
|---|---|---|
| | Additive wt. % and | Above 100 mAh (63% |
| Additive | Electrolyte Aging Time | Initial Capacity Retention) |
| A3 | 1%, 2 weeks aged | 144 |
| Comparative | N/A | 77 |
| Electrolyte 1 | | |
| A1 | 1%, 3 weeks aged | 146 |
| A1 | 1%, 48 hrs aged | 128 |
| A1 | 1%, 1 week aged | 136 |
| A1 | 1%, 2 weeks aged | 141 |
| Comparative | 2% | 166 |
| Electrolyte 2 | | |

TABLE 3B
Summary of Number of Cycles Above 100 mAh at 4.5 V

| | | Number of Cycles |
|---|---|---|
| | Additive wt. % and | Above 100 mAh (56% |
| Additive | Electrolyte Aging Time | Initial Capacity Retention) |
| Comparative | N/A | 50 |
| Electrolyte 1 | | |
| A3 | 1%, 2 weeks aged | 67 |
| A1 | 1%, 2 weeks aged | 63 |
| A1 | 1%, 1 week aged | 68 |
| A1 | 1%, 3 weeks aged | 70 |
| A1 | 1%, 48 hrs aged | 70 |
| Comparative | 2% | 72.5 |
| Electrolyte 2 | | |

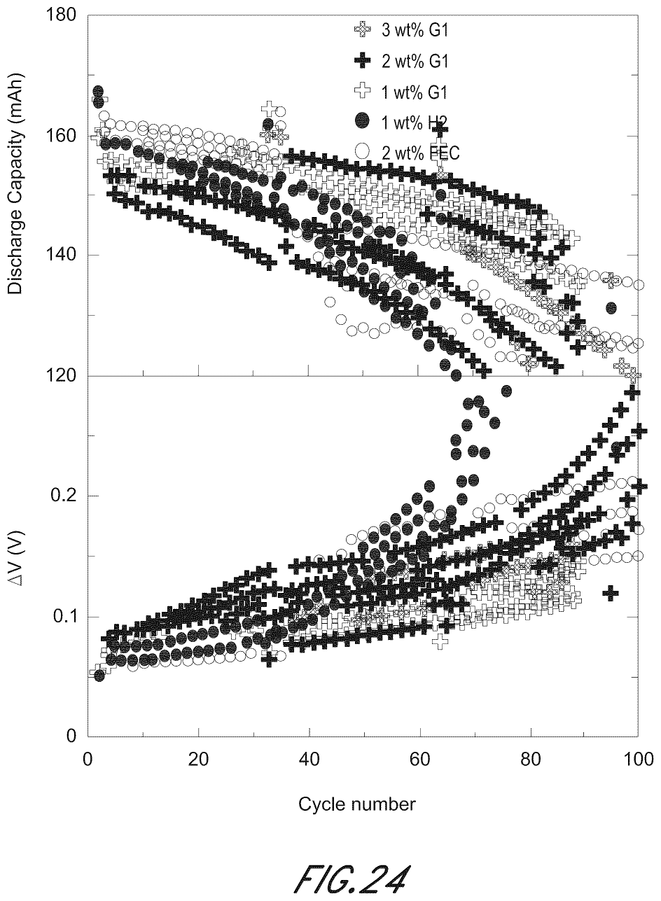

The discharge capacity and difference between average charge and discharge voltage versus cycle number of pouch cells with electrolyte systems comprising a compound according to some embodiments was tested. FIG. 24 illustrates the discharge capacity of NMC442 pouch cells cycled between 3.0 V and 4.4 V at 40° C., with electrolyte systems including:
(a) 2 wt. % FEC and 3 wt. % additive G1 (“3N1-8 A-TMSCN”);
(b) 2 wt. % FEC and 2 wt. % additive G1 (“2N1-8 A-TMSCN”);
(c) 2 wt. % FEC and 1 wt. % additive G1 (“1N1-8 A-TMSCN”);
(d) 2 wt. % FEC and 1 wt. % additive H2 (“N3-2 A-HTCN”); and
(e) 2 wt. % fluoroethylene carbonate (FEC) (“2FEC”).

As seen in FIGS. 24, the addition of G1 or H2 provided improved discharge capacity over the baseline electrolyte system which only included 2 wt. %. FEC. Electrolyte systems with 1 wt. % of additive H2 provided superior average charge and discharge voltages after about 60 cycles, relative to the control electrolyte system. In addition, electrolyte systems with 3 wt. % of additive H2 provided superior average charge and discharge voltages after about 80 cycles, relative to the control electrolyte system.

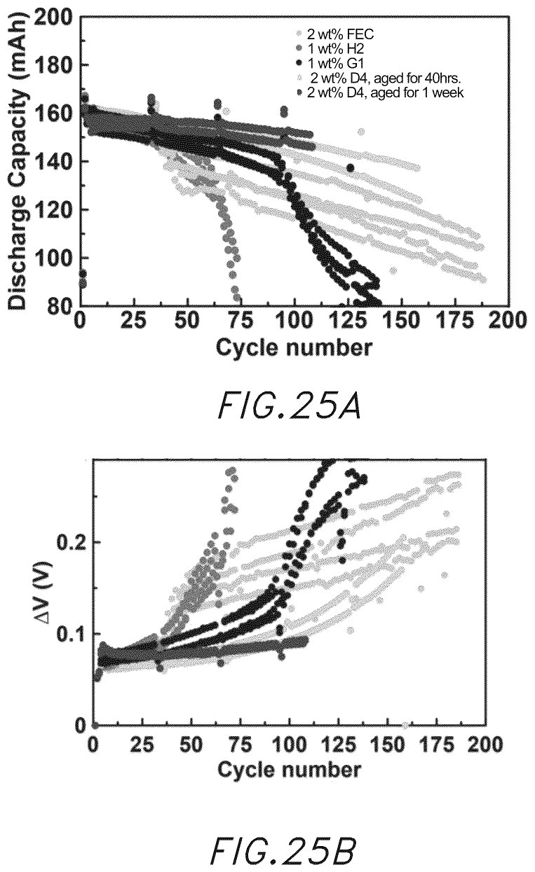

FIG. 25A illustrates the discharge capacity of NMC442 pouch cells cycled between 3.0 V and 4.4 V at 40° C., with electrolyte systems including:
(a) 2 wt. % fluoroethylene carbonate (FEC) (“2% FEC”)
(b) 2 wt. % FEC and 1 wt. % additive H2 (“1% N3-2-HTCN”);
(c) 2 wt. % FEC and 1 wt. % additive G1 (“1% N1-8-TMSCN”);
(d) 2 wt. % FEC and 2 wt. % additive D4 aged for 40 hours (“2% S2-3-bTMSCN-40hrsaged”); and
(e) 2 wL % FEC and 2 wt. % additive D4 aged for one week (“2% S2-3-bTMSCN-1 weekaged”).

FIG. 25B shows the difference between average charge and discharge voltage versus cycle number of pouch cells with utilizing the same electrolyte formulations as FIG. 25A. As seen in FIGS. 25A, the addition of aged additive D4 provided improved discharge capacity over the baseline electrolyte system, which only included 2 wt. %. FEC. In addition, electrolyte systems with 2 wt. % additive D4 aged for one week provided cells with robust average charge and discharge voltages even after over 100 cycles.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The invention claimed is:

1. An electrolyte comprising at least one of Formula (A), Formula (B), Formula (C), Formula (D), or a polymeric component that comprises a unit of Formula (E), or a salt thereof: 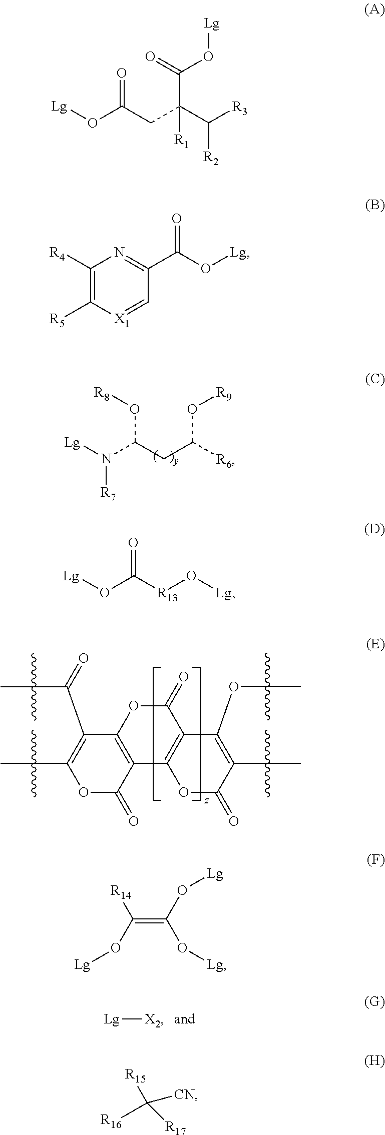
wherein: [symbol]
is selected from the group consisting of a single bond and a double bond;
R₁ is selected from the group consisting of —H, —OLg and absent;
each of R₂ and R₅ are independently selected from the group consisting of —H and —COOLg;
R₃ is selected from the group consisting of —COOLg and —CH₂COOLg;
R₄ is selected from the group consisting of —H, —OLg and —COOLg;
X₁ is selected from the group consisting of C and N;
R₆ is selected from the group consisting of —N(R₁₀)Lg, —OLg and —NLg;
R₇ and R₁₀ are independently selected from the group consisting of —H, an aryl group, an alkyl group, -Lg and absent;
each of R₈ and R₉ are independently selected from the group consisting of -Lg and absent;
R₁₃ is selected from the group consisting of —CH₂—, —C(O)—, —C(CH₃)₂—, —CH₂C(O)—, —C(CH₃)₂CH₂—, —C(CH₃)₂C(O)—, —(CHCH)_{w}C(O)—, —(CH₂CH₂)_{w}C(O)—, and —(C≡C)_{w}(O)—;
R₁₄ is selected from the group consisting of —H, —OLg and —COOLg;
each of R₁₅, R₁₆ and R₁₇ are independently selected from the group consisting of —H, —CN, an alkyl group and a cyanoalkyl group;
X₂ is selected from the group consisting of —CN, —NCO, and —NCS;
w is an integer in the range of 1 to 10;
y is 0 or 1;
z is an integer in the range of 1 to 100; and
Lg is selected from the group consisting of trimethylsilyl (TMS) and toluenesulfonyl (CH₃C₆H₄SO₂).

2. (canceled)

3. (canceled)

4. (canceled)

5. (canceled)

6. The electrolyte of claim 1, wherein the electrolyte comprises Formula (A), or a salt thereof.

7. (canceled)

8. (canceled)

9. (canceled)

10. (canceled)

11. The electrolyte of claim 6, wherein the salt form of Formula (A) is selected from the group consisting of 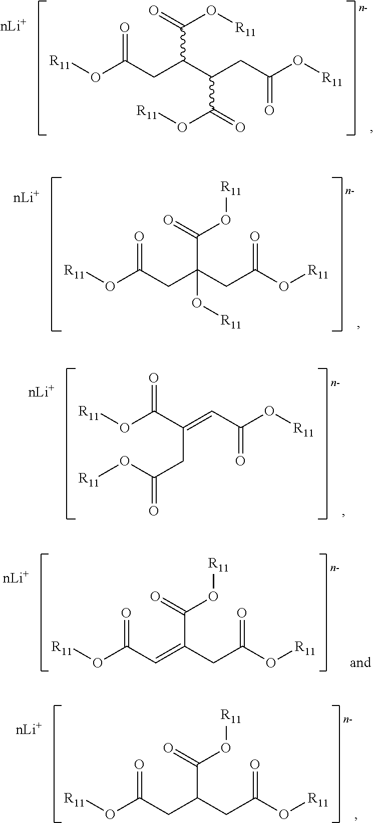
R₁₁ is selected from the anionic group consisting of PF₆⁻¹, BF₄⁻¹, and difluoro(oxalato)borate (DFOB⁻);
n is the number of anionic groups.

12. The electrolyte of claim 6, wherein a compound of Formula (A), or a salt thereof, is selected from the group consisting of

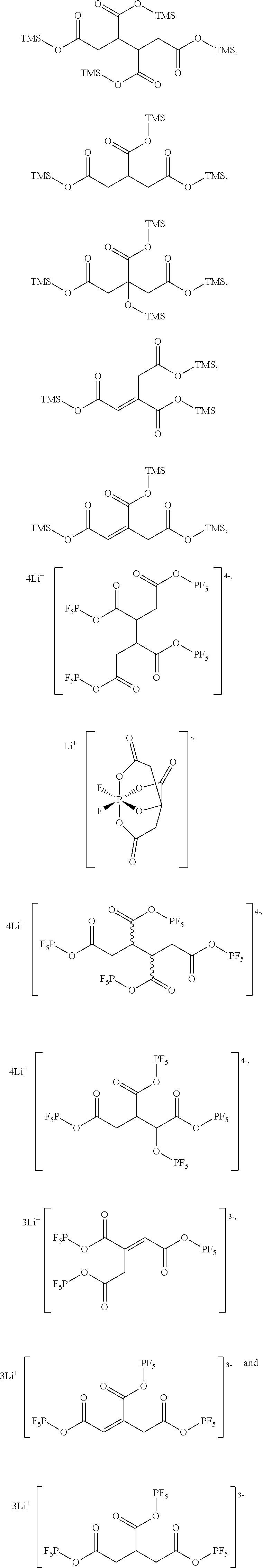

13. The electrolyte of any one of claim 1, wherein the electrolyte comprises Formula (B), or a salt thereof.

14. (canceled)

15. (canceled)

16. (canceled)

17. The electrolyte of claim 13, wherein a compound of Formula (B), or a salt thereof, is selected from the group consisting of

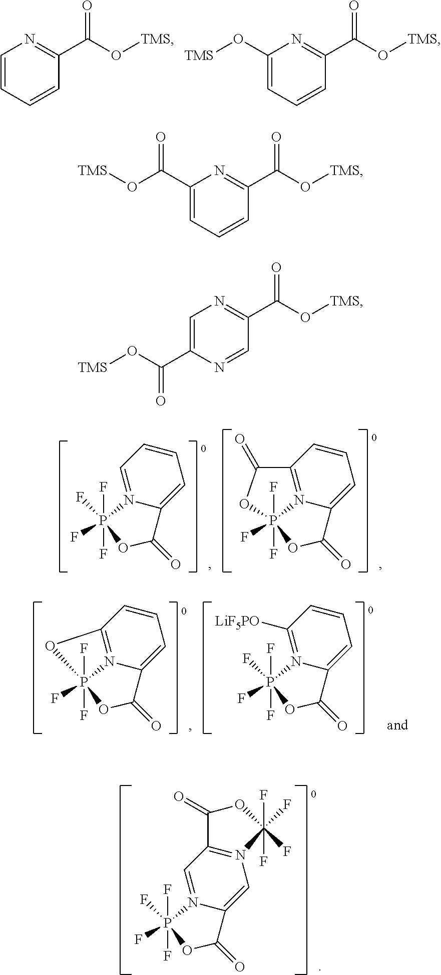

18. The electrolyte of claim 1, wherein the electrolyte comprises Formula (C), or a salt thereof.

19. (canceled)

20. (canceled)

21. (canceled)

22. (canceled)

23. (canceled)

24. (canceled)

25. The electrolyte of claim 18, wherein a compound of Formula (C), or a salt thereof, is selected from the group consisting of

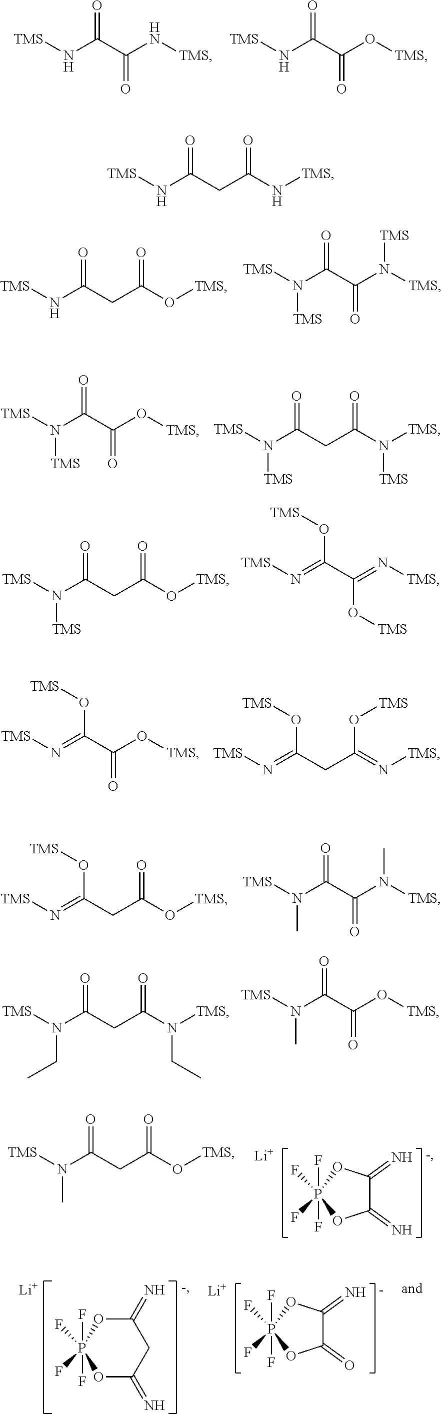

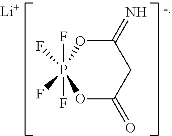

26. (canceled)

27. The electrolyte of claim 1, wherein the electrolyte comprises Formula (D), or a salt thereof.

28. (canceled)

29. The electrolyte of claim 27, wherein a compound of Formula (D), or a salt thereof, is selected from the group consisting of

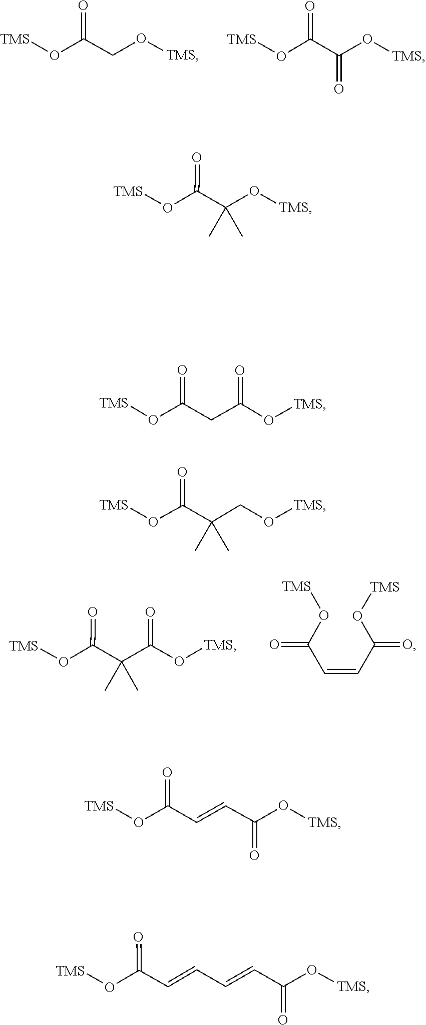

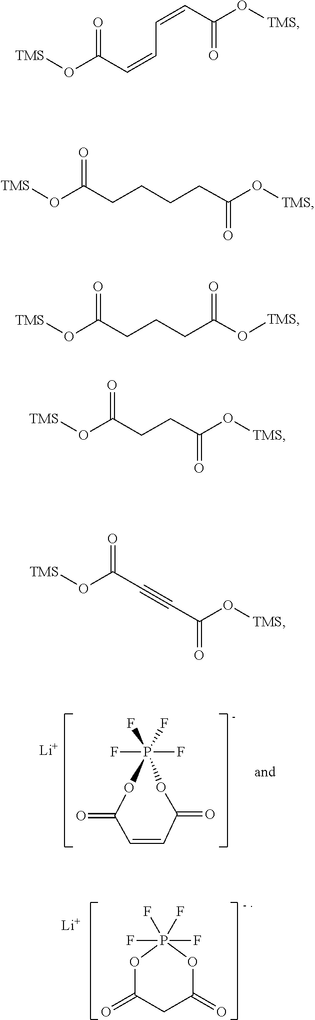

30. (canceled)

31. The polymeric component of claim 1, wherein the polymeric component comprises a unit of Formula (E).

32. The polymeric component of claim 31, wherein z is an integer in the range of 1 to 10.

33. The electrolyte of claim 1, wherein the electrolyte comprises Formula (F), or a salt thereof.

34. (canceled)

35. The electrolyte of claim 33, wherein a compound of Formula (F), or a salt thereof, is selected from the group consisting of

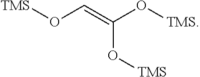 [SMILES: C[Si](C)(C)OC=C(O[Si](C)(C)C)O[Si](C)(C)C]

36. The electrolyte of claim 1, wherein the electrolyte comprises Formula (G), or a salt thereof.

37. (canceled)

38. (canceled)

39. (canceled)

40. (canceled)

41. (canceled)

42. The electrolyte of claim 36, wherein a compound of Formula (G), or a salt thereof, is selected from the group consisting of TMS-CN, TMS-NCO, TMS-NCS,

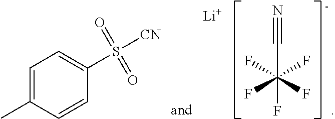

43. (canceled)

44. The electrolyte of claim 1, wherein the electrolyte comprises Formula (H), or a salt thereof.

45. (canceled)

46. (canceled)

47. (canceled)

48. (canceled)

49. The electrolyte of claim 44, wherein a compound of Formula (H), or a salt thereof, is selected from the group consisting of

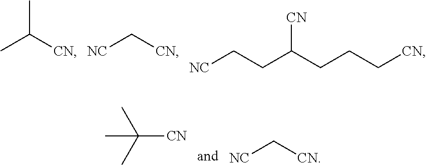

50. (canceled)

51. The electrolyte of claim 1, wherein the electrolyte further comprises a solvent and a lithium salt.

52. An energy storage device, comprising:
the electrolyte of any one of claim 1;
a cathode;
an anode; and
a housing, wherein the electrolyte, cathode and anode are disposed within the housing.

53. (canceled)

54. The energy storage device of claim 52, wherein the energy storage device has a discharge capacity retention when cycled up to 4.4V of at least about 90% after 50 cycles.

55. A method of preparing an energy storage device, comprising:
preparing the electrolyte of claim 1; and
positioning the electrolyte within a housing comprising a cathode and an anode.

56. The method of claim 55, wherein preparing comprises combining at least one of Formula (A), Formula (B), Formula (C), Formula (D), Formula (F), Formula (G), Formula (H) and the polymeric component that comprises a unit of Formula (E), or a salt thereof, the solvent and the lithium salt to form the electrolyte, and aging the electrolyte prior to positioning the electrolyte within the housing.

57. The method of claim 55, wherein the electrolyte is aged for about 2-48 hours.
